(19) United States
(12) Patent Application Publication
(10) Pub. No.: US 2024/0303236 A1
(43) Pub. Date: Sep. 12, 2024

(54) SYSTEM AND METHOD FOR RELATIONAL DATABASE QUERY ANSWERING AND OPTIMIZATION BASED ON NATURAL ALGEBRA OF K-RELATIONS

(71) Applicant: Starcounter AB, Stockholm (SE)

(72) Inventors: Andrey Andreev, Sollentuna (SE); Henrik Sjöström, Lidingo (SE); Daniil Skatov, Bagarmossen (SE)

(21) Appl. No.: 17/773,291

(22) PCT Filed: Oct. 29, 2020
(86) PCT No.: PCT/SE2020/051049

§ 371 Date: Apr. 29, 2022

(30) Foreign Application Priority Data
Nov. 1, 2019 (SE) 1930357-7
Nov. 18, 2019 (SE) 1951327-4

(51) Int. Cl. G06F 16/2453

(52) U.S. Cl. CPC G06F 16/24537

(57) ABSTRACT

This disclosure presents a system and method for representing, transforming, and answering, database queries based on formalisms for k-relations and operations on them, wherein all the operations are derived from the two basic ones: natural join and natural union, so their algebraic properties are also derived. The disclosure suggests implementations of these formalisms in the embodiments of the invention. In particular, the examples presented in this disclosure encompass the translation of the full spectrum of features and functionality of the relational database queries (SQL examples) as well as the essential functionality of the object-relational and graph database queries (Starcounter QL examples). The algebraic expressions resulting from the said translation can be further rewritten using the transformation rules, and eventually mapped to an executable form for any given embodiment.

### TECHNICAL FIELD

The present disclosure relates to a device, system and method for answering relational database queries, object-relational database queries, and graph database queries.

### BACKGROUND

Relational model is historically and practically the most common way of expressing all kinds of data which are stored and accessed by software applications. A number of query languages exist, most notably different versions and dialects of SQL, and LINQ. Key-value stores and RDF stores can be regarded as particular cases of the relational model, and can be queried with certain useful (albeit not necessary) extensions of these query languages. General-purpose object stores and graph databases also exhibit many features of the relational model, and can be mapped to it.

The theoretical foundation of the relational model is the Relational Algebra. It was originally formulated by Edgar F. Codd in 1970-es, defining relations as sets of tuples, and employing a number of basic operators, such as unions, joins, projections, etc. An important problem, however, is that most software applications prefer to deal with multisets—often because it better reflects the application semantics (duplicate tuples do matter), and anyway because removing duplicates is expensive, and so better avoided unless really needed.

### SUMMARY

Embodiments presented herein offer the advantage of representing, transforming, and answering all kinds of queries against relational databases (such as those expressed in LINQ, SQL, and their object/graph oriented extensions) as algebraic expressions, by providing formal infrastructure for representing relational data model and the operations over it, and representing different query optimization techniques as sets of transformation rules applicable to the said algebraic expressions.

According to the first aspect, there is provided a system (100) for representing, optimizing, and answering queries against relational databases, or object-oriented databases, or graph databases.

The system comprises specification of tuples and k-relations (111), where rows, object instances, or graph nodes and edges are represented by tuples, and stored collections of rows, object instances, or graph nodes and edges are represented by k-relations, wherein the collections represented are either sets or multisets. Besides being the basis of the system (100), this additional allows common data representation for multi-model databases.

The system further comprises specification of two basic algebra operators: natural join (113) and natural union (114), which allow deriving one or more other database algebra operators as a composition of these two basic operators over the stored k-relations (111), empty k-relations, and generated sets (112), which are infinite k-relations finitely computable for the purpose of the natural join in the context of the query being processed. This allows reasoning about the algebraic properties of the derived operators in a uniform way, defining transformations which are known to produce equivalent forms, and optionally defining the said transformations only in terms of the two basic operators.

The system further comprises means for representing database queries as natural algebra expressions, which are expressions comprising one or more of a natural join operator (113), a natural union operator (114), and other derived operators (120) over stored or generated k-relations. This algebraic representation is general enough to express queries translated from a number of different query languages, including relational, object-relational, and graph query languages, and further allows for different forms of query interoperability and multi-query optimization across languages.

The system further comprises means for transforming the said expressions by systematically applying transformation rules, including specification of these rules, and sets of rules for separate query processing tasks such as simplification, normalization, logical and physical optimization. This constitutes a framework for more general and powerful query optimization than what is available in database management systems based on algebras involving greater number of independently defined operators, and in systems which do not employ algebraic representations of database queries.

According to a further aspect, there is provided a method (200) for relational, object-relational, or graph query answering based on a sequence of algebraic representations (221, 241, 242, 243).

The method comprises translating (211-219) a database query (201-209), to a Natural Algebra representation (221), thus obtaining a general and language-independent equivalent of the said query, which allows reasoning about its properties, and serves as a basis for the next step.

The method further comprises systematically applying (230) transformation rules (231-233) in order to transform the Natural Algebra representation (241) of the query being processed to a logically optimized representation (242), and eventually to a physically optimized executable representation (243). This unifies a number of query optimization techniques within a single framework, where each step or approach is expressed declaratively as a set of transformation rules.

The method further comprises evaluating (280) the physically optimized executable representations against a database instance (270) in order to obtain a query answer (290). Evaluating an executable Natural Algebra expression, independent of the query language, further allows having a single execution mechanism for a number of high-level data models and query languages, which are translatable to Natural Algebra. It further allows cross-query runtime optimization across data models.

The method (200) assumes that at least the final algebraic query representation (243) is executable in each particular embodiment. For this purpose, an embodiment should include an execution engine (280) which accepts an algebraic query representation where all operators are physical operators. The execution engine is still free to perform certain transformations (such as cost-based join ordering). Though the particular design of the execution engine (280) is out of the scope of this disclosure, the method (200) dictates that the database data (270) can only be accessed at the query answering stage (280) when the executable NA translation (243) is already obtained. This allows decoupling the query execution part of query answering from query optimization, the latter being facilitated by algebraization (210) and transformations (230). In contrast, database schema (250), index catalog and statistics (260) are available during the query optimization stages.

According to a further aspect there is provided a computer program loadable into a memory communicatively connected or coupled to at least one data processor, comprising software for executing the method according to any of the embodiments presented herein when the program is run on the at least one data processor.

According to yet another aspect there is provided processor-readable medium, having a program recorded thereon, where the program is to make at least one data processor execute the method according to of any of the embodiments presented herein when the program is loaded into the at least one data processor.

Embodiments presented herein offer the advantage of representing, transforming, and answering all kinds of queries against relational databases (such as those expressed in LINQ, SQL, and their object/graph oriented extensions) as algebraic expressions, by providing formal infrastructure for representing relational data model and the operations over it. All such operations are derived from the two basic ones: natural join and natural union, so their algebraic properties are also derived. This allows a uniform representation of database queries, and more general and powerful query optimization, among other things.

### BRIEF DESCRIPTION OF THE DRAWINGS

The invention is now to be explained more closely by means of preferred embodiments, which are disclosed as examples, and with reference to the attached drawings.

FIG. 1 shows a schematic overview of a system according to one or more embodiments;

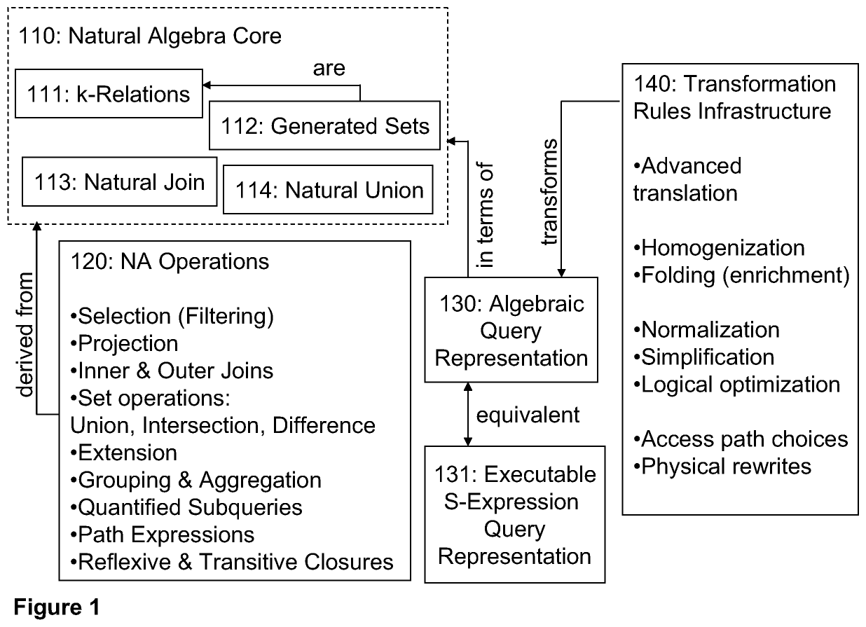

FIG. 2 is a flow chart of a method according to one or more embodiments.

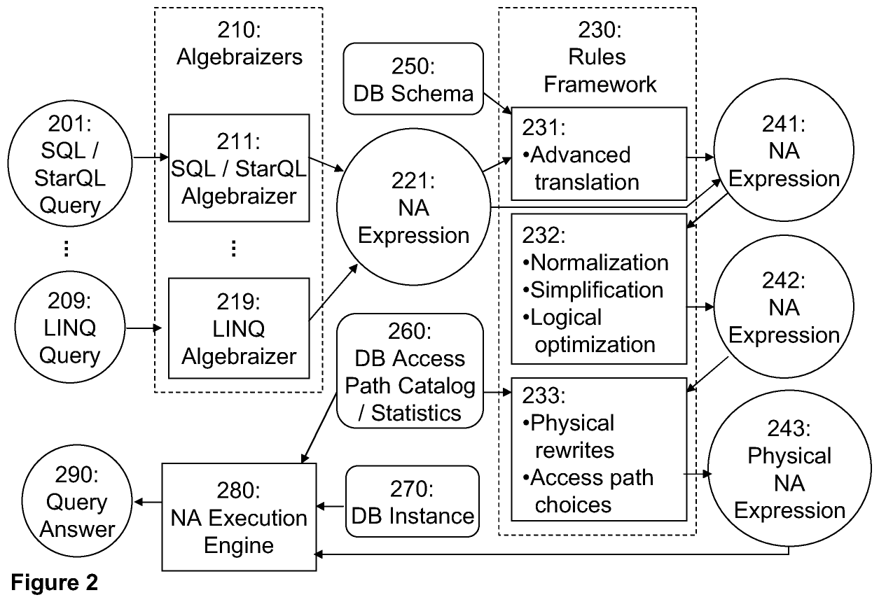

### DETAILED DESCRIPTION

### Introduction

The present disclosure describes a system and method for answering all kinds of queries against relational databases, or any databases which expose (are mapped to) the relational data model. This is done by specifying algorithms data structures for representing relational data model and the operations over it, and by translating any SQL, LINQ, and other relational queries to algebraic expressions, which are transformable and executable within this infrastructure.

We start by describing natural algebra in terms of its types (data structures) and operators, and then cover the related practical aspects of query processing, such as algebraization and execution. We then continue with an extended set of examples in Section 2 each of these examples is designed to demonstrate one of the basic features of the practical database queries, and their handling within our system (100), by applying the steps of the method (200).

A more step-by-step overview of the algebraization method is given in Section 3 using SQL as an example language. The framework for rule-based query optimization, is presented in Section 4. Section 5 provides more examples in application to the object/graph query language Starcounter QL. Section 6 discusses different options for the execution environment, where Natural Algebra expressions are used to obtain query results.

### 1. Natural Algebra

### 1.1 Tuples and K-Relations

In this formal infrastructure, the queriable data is represented by k-relations, which are multisets of tuples of named values. Tuples map named attributes to the values of the respective domains, for example, t= [symbol] name→‘John’, age→32 [symbol] (despite the angular brackets notation, the order of the mappings does not matter), and k-relations map a set of tuples to numeric-valued multiplicities, for example, A={t*1, u*3}. The multiplicity of a tuple t in a k-relation A is denoted as k_{A} (t) We say that a k-relation ‘contains’ a tuple, t∈A if and only if its multiplicity is non-zero: k_{A} (t)≠0.

An equivalent way of defining k-relations would be to attribute multiplicities k(t) to tuples per se, thus defining k-tuples, [symbol] a→a(t), b→b(t), . . . , k(t) [symbol] , and k-relations would be sets of such k-tuples. All the definitions given below can be re-reformulated based on such formalism as well, but theorem proofs would become more complex, since they will have to deal with multiple equivalent set representations of the same k-relation.

The header H(t) of a tuple is the set of all attributes which it maps to values, but the header H(A) of a k-relation is always explicitly given as part of its definition. For example, if a k-relation represents a table in a relational database, the header of such k-relation is the set off its column names and the associated data types. This also allows empty k-relations ∅_{X} with a specified header X. A tuple may also be empty, as denoted by [symbol] [symbol] and a k-relation containing only an empty tuple with multiplicity n is called a scalar k-relation: { [symbol] [symbol] *n}.

In some embodiments the ‘stored’ or ‘basic’ k-relations may be required to contain only non-negative integral mutiplicities of tuples, which covers the needs of all the mainstream relational databases, and all datasets which can be mapped to such databases (relational databases, object stores, RDF, graph databases, etc.) However, this is not a requirement for the Natural Algebra, it merely makes certain traditional query optimization techniques readily applicable. Other embodiments might represent probabilistic data, fuzzy sets, or other continuous measures of existence by utilizing real-valued multiplicities.

Also, as demonstrated in Example 11 (set difference) and Example 15 (antijoin), negative multiplicities are useful, and k-relations containing negative multiplicities of tuples may be created as intermediate results, or used to represent updates to the database.

### 1.2 Natural Join

One basic operation on k-relations is natural join [symbol] which produces a k-relation consisting of joined pairs of the compatible tuples from the argument k-relations. Two tuples are compatible t↔u if and only if they map the same attributes to the same values, for example, t= [symbol] name→‘John’, age→32 [symbol] and v= [symbol] name→‘John’, ssn→1234 [symbol] . By joining compatible tuples we obtain a tuple containing union of the mappings: t·v= [symbol] name→‘John’, age→32, ssn→1234 [symbol] . In particular, two tuples with non-overlapping headers are always compatible, and their join is always defined. Also, since mappings in the tuple are not ordered, tuple join is commutative: t·v=v·t.

Natural join operation of two k-relations joins all pairs of the compatible tuples from its left and right arguments, and multiplies their respective multiplicities:

$$A B {=}^{Def} \{ t \cdot u * {k}_{A} ( t ) \cdot {k}_{B} ( u ) : t ∈ A ⋀ u ∈ B ⋀ t ↔ u \}$$

The header of the result of a natural join is defined as union of headers of its operands:

$$H ( A B ) {=}^{Def} H ( A ) ⋃ H ( B )$$

Natural join operation is commutative and associative, and uses scalar k-relation { [symbol] [symbol] *1} as the identity element. Therefore Natural Algebra is a commutative monoid with respect to the natural join operation.

Different embodiments may include different implementations of the natural join operation, depending on the internal representation of k-relations, available access paths to tuples with specified values (i.e. database indexes), and other technical choices. The most common examples are nested-loop join (either using scans or index lookups), hash join, and sort-merge join,

More optimized implementations of join operation may be included for the specialized cases, such as joining under many-to-one guarantee, which is typically provided by non-nullable foreign keys in the relational databases, or for joining sets of nodes/objects which directly link one to another, as is usually the case in graph databases/object stores.

### 1.3 Natural Union

Another basic operation is natural union + producing a k-relation containing the ‘common’ parts of all tuples in the argument k-relations, with the multiplicities of the matching tuples summed up.

$$A + B {=}^{Def} \{ t * ( {k}_{{\prod }_{X} ( A )} ( t ) + {k}_{{\prod }_{X} ( B )} ( t ) ) : t ∈ Dom ( X ) \}$$

where X is the common set of attributes of the operand k-relations, which is also the header of the result of the natural union:

$$X = H ( A + B ) {=}^{Def} H ( A ) ⋂ H ( B )$$

For example, the natural union of k-relations each containing a single instance of tuple t and v from the previous example, would contain two instances of tuple mapping the only common attribute: {t*1}+{v*1}={ [symbol] name→‘John’ [symbol] *2}

Natural union operator is commutative and associative, and uses empty k-relation Øs with the universal header Ω as the identity element. Therefore Natural Algebra is a commutative monoid with respect to the natural union operation. We do not claim the inversibility property of the natural union operator (which would make Natural Algebra an abelian group w.r.t. this operator). Even though for each k-relation A there exists an ‘inverse’ k-relation

$$- A {=}^{Def} \{ 〈 〉 * - 1 \} A ,$$

the result of natural union A+(−A)=∅_{H(A)} depends on the header of A, and does not produce the aforementioned identity element ∅_{Ω}.

The domain Dom(X) is the (potentially infinite) set of all possible tuples with header X. Though the definition above implies running t through an infinite domain, any embodiment will have to include a finite-time and finite-space implementation of the natural union. This is certainly possible, since parts of only those tuples which are contained in at least one of the operands will get a non-zero multiplicity in the result of the natural union.

The above notation assumes that attributes are identified by name and domain, i.e. there cannot be attributes with same names but different domains in headers of k-relations.

However, this is not the case in the classical relational databases, as one can define tables with homonymic columns of different types, and then try to compute a relational union of such tables. Embodiments which are designed to be compatible with existing database management systems supporting SQL need a specific implementation of natural union, which would emulate the behavior of SQL union operation in this aspect -either throwing an error if the domains are different, or trying to construct common wider domain for the respective attribute in X.

### 1.4 Relationship Between Natural Join and Natural Union

Natural join and natural union are symmetrical in a certain way. Natural join collects only matching tuples, while widening header, and natural union collects all the tuples, but narrows the header.

The distributivity of natural join across natural union requires that the set of attributes participating in the natural join remains the same:

$$∀ A ∀ B ∀ C : H ( B ) ∩ H ( A ) = H ( C ) ∩ H ( A ) ⇒ A ( B + C ) = A B + A C$$

The conditions for the distributivity of natural union across natural join are much more restrictive—it is required that all headers are the same, and the k-relation A is flat (i.e. contains each distinct tuple with multiplicity 1) and disjoint from the others (i.e. produces empty natural join with either of them):

$$∀ A ∀ B ∀ C : H ( A ) = H ( B ) = H ( C ) ⋀ A A = A ⋀ A ( B + C ) = {⌀}_{H ( A )} ⇒$$

$$⇒ A + B C = ( A + B ) ( A + C )$$

Since the distributivity laws do not hold in general, we do not claim Natural Algebra being any sort of a ring-like algebraic structure.

### 2. Example of Translating SQL Queries to Natural Algebra

The examples 0-21 below show practical usage of Natural Algebra for representing queries in standard SQL. Further examples, featuring a query language extended for querying graph databases and object stores are provided in Section 5. Every Natural Algebra expression is executable in any embodiment, implying that every operator is either defined in terms of other operators (ultimately, in terms of natural join and natural union), or has at least one implementation in that embodiment.

Also, any Natural Algebra expression is easily transformable to equivalent expressions using transformation rules. Some embodiments may define physical (executable) operators which correspond to complex patterns of Natural Algebra subexpressions, such as Range₍ₓ_{₀}_{,x}_{₁}^{x}(B) in the note after Example 7, together with transformation rules which introduce such physical operators into the natural algebra expression. This kind of rule-based rewrites is an essential part of query optimization.

In the preferred embodiment any Natural Algebra expression is stored and processed in the machine memory as an executable S-expression consisting of operators and their arguments. Such representations are provided in every example below.

### Example 0. Header Tracking

In order to accommodate different kinds of equi-joins, theta-joins, and subqueries in SQL, every table/class listed in the FROM clause of an SQL query is translated to Natural algebra along with its alias in the query (or the table name itself acting as the default alias). A simplest SQL query
SELECT * FROM A
   is translated to Natural Algebra as

$$Q = {ρ}_{A .} ( A )$$

where ρ_{P.} is the prefixing operator, which transforms the header of its argument relation, by prefixing each attribute name with the specified prefix P. We can also express the header of the result of this query, by prefixing the header expression:

$$H ( Q ) = A . H ( A ) .$$

meaning that for every attribute aᵢ∈H(A) there will be a corresponding attribute A.aᵢ in the result.

The formal definition of ρ_{P.}, which ultimately builds on natural join and natural union is provided in the Example 4 below. However, since this operator does not touch the actual data, any embodiment is likely to have a simple implementation for it. An expression ρ_{A.}(A) is also a good target for partial computation, since it only depends on the table alias (coming from the query) and table columns (coming from database metadata), which are available before query execution.

A preferred embodiment, representing Natural Algebra expressions as executable Lisp S-expression, thus providing full compositionality, also defines PREFIX operator for this purpose. The S-expression equivalent of the above translation would be
(PREFIX A “A”)

As we will see later, theta-joins, equi-joins and Cartesian products, which always need to distinguish between the attributes coming from left and right operands, provide a notational facility/‘syntactic sugar’ for prefixing.

### Example 1. Selection

Most of the work on the relational algebra so far is only concerned with so-called SPJ queries, i.e. queries which contain only select, project, and join operators of the relational algebra. The following SQL query is an isolated example of the selection operation:
SELECT * FROM A WHERE x>0

Here a predicate P(t)=(x(t)>0), is applied to every tuple t∈A. We represent such query with a Natural Algebra expression

$$Q = {ρ}_{A .} ( A ) \{ A . x > 0 \}$$

or an executable S-expression in the preferred embodiment:
(N-JOIN (PREFIX A “A”) (FILTER (NP.>A.x 0)))

In this representation, {A.x>0} is a generated set-a possibly infinite k-relation with header {A.x} and a tuple with each possible value for x such that x>0 is true.

In the preferred embodiment, the constructor macro (FILTER (NP.>A.x 0)) creates such a generated k-relation which, receiving the known values of x through the natural join, either produces a compatible tuple [symbol] A.x [symbol] or not. The scalar null-propagatating function NP.> will not raise an error if x is Null, returning Null as a result instead, which in this case would be effectively same as false.

### Example 2. Projection

Another typical SQL query is a selection of some of the columns from each tuple in a relation, known as the projection operation:
SELECT x FROM A

The projection operator Π in Natural Algebra can be expressed as a natural union with an empty k-relation with the specified header, hence two options of the representation

$$Q = {Π}_{\{ A . x \}} ( {ρ}_{A .} ( A ) ) = {⌀}_{\{ A . x \}} + {ρ}_{A .} ( A )$$

In the preferred embodiment there are both ‘operator-rich’ and ‘operator-homogenic’ equivalent configurations of the same expressions, so the equivalent representations are
(PROJECT (PREFIX A “A”) #(A.x))
and
(N-UNION (EMPTY #(A.x)) (PREFIX A “A”))

### Note on Transformation Rules

Any embodiment supporting alternative configurations of the equivalent Natural Algebra expressions can be equipped with transformation rules to perform such rewrites in at least one of the directions, for example

$${\prod }_{X} ( A ) ⟶ {∅}_{X} + A$$

which is a context-free rule with symbols A and X. A reverse transformation,

$${∅}_{X} + A ⟶ {\prod }_{X} ( A )$$

is also context-free, however, it needs to handle associative cases of the n-ary natural union+operator.

The whole rule-based transformation framework is part of the system and method for optimizing Natural Algebra representations of the relational database queries, described in Section 4 below and is part of the patent claims.

### Example 3. Extension

SQL allows giving output columns specific names. The simplest case is renaming a projected column:
SELECT x AS z FROM A

A direct Natural Algebra representation would include an extension with a generated set:

$$Q = {Π}_{\{ z \}} ( {ρ}_{A .} ( A ) \{ z = A . x \} )$$

or, in the preferred embodiment, as an executable S-expression
(PROJECT (N-JOIN (PREFIX A “A”) (EXTEND z A.x)) #(z))

Here the constructor macro (EXTEND z A.x) creates such a generated k-relation which, receiving the known values of x through the natural join, always produces a compatible tuple [symbol] x, z [symbol] such that the value for z is provided by the scalar expression A.x.

Any valid scalar expression that would appear before AS in the SELECT clause of an SQL query can be translated to an S-expression which comes as the last argument to EXTEND.

### Note on Multidirectional Generated Sets

In the most general case, a generated set G={P(Z)}, having the header Z, based on predicate P(Z) which is dependent on the set of attributes Z, consists of a number of computable directions dᵢ= [symbol] Zᵢ, pᵢ, gᵢ [symbol] . Here each Zᵢ ⊆Z is a set of bound variables required for computation, predicate pᵢ(Zᵢ) defines whether a tuple with given values for Zᵢ should be present in the generated set, and if so, function gᵢ(Zᵢ) generates a whole tuple with header Zᵢ directly copying the values for the attributes in Zᵢ and computing the values for the remaining attributes in Z\Zᵢ.

By default, a generated set constructed with (FILTER P(X)) has single direction d= [symbol] X, P(X), t_{X} [symbol] and a generated set constructed with (EXTEND y f(X) has a single direction d= [symbol] X true, t_{X}·(y→f(X)) [symbol] . In this notation, input tuple t_{X} with header X is extended with an extra mapping (y→f(x)).

However, in certain important cases more directions can be included. For example, if a filter predicate has a form P(X)=(y=f(X′), where X′=X\{y}, an additional direction d′= [symbol] X′, true, t_{X′}·(y→f(X′)) [symbol] is included into the generated set, which effectively means that a ‘filter’ is always true. By transforming the scalar expressions inside the predicate, more equivalent forms of P(X) can be derived, with different variables singled out on one side of the equality—hence more computable directions.

A natural join A [symbol] G of a finite k-relation A with a generated set G={P(Z)} is finitely computable if and only if there exists a direction [symbol] Zᵢ, pᵢ, gᵢ [symbol] ∈=G such that Zᵢ⊆H(A).

For example, consider a Natural Algebra expression A [symbol] B [symbol] {x=y}, where x∈H(A)\H(B) and y∈H(B)\H(A). If the generated set were produced by a FILTER constructor
(N-JOIN A B (FILTER (EQUAL x y))) it would by default have the only direction with the set of bound variables {x, y}, so the joins can only be ordered as (A [symbol] B) [symbol] {x=y}. However, if a direction [symbol] {x}, true, {x}·(y→x [symbol] is added, then the join order (A [symbol] {x=y}) [symbol] B, is also possible, and is likely to be preferred by the query optimizer, since it offers one more join attribute for B, which means better join selectivity and more opportunities for index utilization.

### Example 4. Equi-Join

In English, the following query could be phrased as “return all columns from tables A and B and all rows where value in column x in A matches the value in column y in B”. This query involves an equi-join operation, which is very common in queries of the mainstream relational database management systems, but is not fully supported by the existing algebraic approaches so far.
SELECT * FROM A JOIN B ON A.x=B.y

This query translates to Natural Algebra using the corresponding equi-join operator:

$$Q = {{ρ}_{A .} ( A )}_{〈 A . x 〉} {〈 B . y 〉}_{} {ρ}_{Q .} ( B )$$

or, in the preferred embodiment, as a computable S-expression with E-JOIN:
(E-JOIN (PREFIX A “A”) (PREFIX B “B”) #(A.x) #(B.y))

As was mentioned earlier, we have only two basic operators in Natural Algebra: natural join [symbol] and natural union +. An equi-join, in the general case, is defined for the aligned vectors \dot{X}= [symbol] a₁, . . . , aₙ [symbol] and \dot{Y}= [symbol] b₁, . . . , bₙ [symbol] of the names of those attributes which participate in the equality requirement:

$${A}_{\dot{X}} {\dot{Y}}_{} B {=}^{Def} A B \{ {{⋀}_{i = 1}}^{n} {a}_{i} = {b}_{i} \}$$

and is only defined if H(A)∩H(B)=∅, so that the result of an equi-join contains all attributes from both of its arguments. This condition is typically provided by prefixing operators inserted into the translation.

The above query can be rewritten, according to the definitions of equi-join, as:

$$Q = {ρ}_{A .} ( A ) {ρ}_{B .} ( B ) \{ A . x = B . y \}$$

or, as an executable S-expression in the preferred embodiment:
(N-JOIN (PREFIX A “A”) (PREFIX B “B”) (FILTER (EQUAL A.x B.y)))

Here {A.x=B.y} is a generated set with columns A.x and B.y and all possible values for A.x and B.y from the respective domain(s), such that the equality holds.

The renaming operator ρ (corresponding to the PREFIX function in the S-expression) is also ultimately defined via natural join, natural union (as projection), and a filtering generated set:

$${ρ}_{P .} ( A ) {=}^{Def} {Π}_{P . H ( A )} ( A \{ {⋀}_{a ∈ H ( A )} P . a = a \} )$$

The query from this example can be expressed in terms of basic operators and generated sets as:

$$Q = ( {⌀}_{A . H ( A )} + ( A \{ {⋀}_{a ∈ H ( A )} A . a = a \} ) ) ( {⌀}_{B . H ( B )} + ( B \{ {⋀}_{b ∈ H ( B )} B . b = b \} ) ) \{ A . x = B . y \}$$

Such verbose representation, however, is not required—neither for internal representation nor for computation of the query as Natural Algebra expression.

### Example 5. Natural Join

Not the most common, but the most basic (i.e. without any explicit conditions) way to join two tables in SQL is to join them on all matching attributes-the so-called natural join:
SELECT * FROM A NATURAL JOIN B

We do not map this to the natural join operator in the Natural Algebra, since we still want to track the provenance of the columns in the result of this query. Instead, we translate SQL natural join as a particular case of an equi-join:

$$Q = {{ρ}_{A .} ( A )}_{A . \dot{X}} {B . \dot{X}}_{} {ρ}_{B .} ( B )$$

where X=H(A)∩H(A) is the set of common attributes of the tables joined, and vector \dot{X} contains these attributes in a certain arbitrary order.

A corresponding executable S-expression in the preferred embodiment is, naturally:

```
(E-JOIN (PREFIX A “A” (PREFIX B “B”)
  (H-PREFIX (H-INTERSECT (H A) (H B)) “A”)
  (H-PREFIX (H-INTERSECT (H A) (H B)) “B”))
```

It should be noted that the natural join operation is rarely directly useful in queries. The main reason is that the result of a query containing natural join operation is sensitive to schema changes, so the same query would return different sets of tuples (albeit the same header) if a column with a matching name is added to or removed from one of the operand tables. In some SQL dialects, such as Microsoft T-SQL, natural join operation is not available at all.

### Example 6. Cartesian Product

Though discouraged in practice, Cartesian product operation is allowed by most query languages, as an extreme form of a join, where no join predicate is supplied or equivalently, if the join predicate is constant true:
SELECT * FROM A, B

This query translates to Natural Algebra using the Cartesian product operator:

$$Q = {ρ}_{A .} ( A ) \times {ρ}_{B .} ( B )$$

or, in the preferred embodiment, as a computable S-expression with E-JOIN, and empty vectors of matching attributes:
(E-JOIN (PREFIX A “A”) (PREFIX B “B”) #( ) #( ))

As can be seen from the latter representation, Cartesian product is the particular case of an equi-join, where vectors \dot{X} and \dot{Y} are empty, i.e. no equalities are required:

$$A \times B {=}^{Def} A {}_{〈 〉} {〈 〉}_{} B = A B$$

which is only defined if H(A)∩H(B)=∅, which is typically provided by inserting rename operators into the translation of an SQL query.

### Example 7. Theta-Join

In SQL, two tables can be joined on any logical condition, not only equality. Consider a slight modification of the query from Example 4:
SELECT * FROM A JOIN B ON A.x>B.y
   which translates to an invocation of the theta-join operator:

$$Q = {ρ}_{A .} ( A ) {A . x > B . y}_{} {ρ}_{B .} ( B )$$

In the preferred embodiment, this corresponds to an executable S-expression joining a Cartesian product with a filtering generated set:

(N-JOIN (E-JOIN (PREFIX A “A”) (PREFIX B “B”) #( ) #( ))
(FILTER (NP.> A.X B.Y)))

In Natural Algebra, theta-join with condition θ(P.X,Q.Y), dependent on attributes X from the left operand and attributes Y from the right operand, is defined as:

$$A {θ ( X , Y )}_{} B {=}^{Def} ( A \times B ) \{ θ ( X , Y ) \}$$

where {θ(X,Y)} is a generated set corresponding to the join predicate. This definition inherits the Cartesian product's requirement of disjoint headers H(A)∩H(B)=∅, which is typically provided by inserting rename operators into the translation of an SQL query. Technically

### Note on Join Predicate Rewrites

In the preferred embodiment, equi-join which is not a Cartesian product has its own implementation, since it can avoid the exhaustive iteration across its both operands: by utilizing the indexes: using the equality filter, it can ‘bind’ the variables for the generated sets, as shown in note to Example 3.

This is not the case for theta-join that, in general, relies on the Cartesian product with join predicate applied to filter its results. However, different embodiments might involve a range of rewrites and other optimizations, in order for theta-join to utilize, for example, range indexes.

Query from this example, represented in Natural Algebra as a natural join of two tables with disjoint headers, and one generated set:

$$Q = {ρ}_{A .} ( A ) {ρ}_{B .} ( B ) \{ A . x > B . y \}$$

cannot join ρ_{A.}(A) with {A.x>B.y} first, since the generated set has a single direction where both A.x and B.y need to be bound. However, some embodiments may implement a physical operator Range_{(-∞,x )}^{y}(B), based on a range index for attribute y in k-relation B, so that for any given value of x it selects all tuples from B such that y<x. Algebraically, this query would be rewritten to

$$Q = {ρ}_{A .} ( A ) {ρ}_{B .} ( {Range}_{( - ∞ , A . x )}^{y} ( B ) )$$

Formally, the expression Range_{(-∞,A.x )}^{y}(B)is a generated set which only requires {A.x} as a set of bound attributes. Such a rewrite avoids the computation of the Cartesian product ρ_{A.}(A) [symbol] ρ_{B.}(B), and, if the range index lookup happens to be selective, drastically reduces the time complexity of answering the query.

### Example 8. Grouping and Aggregation

A simple example of grouping and aggregation query in SQL
SELECT y, SUM (x) AS z FROM A GROUP BY Y translates to an invocation of groping and aggregation operator Ξ:

$$Q = {Ξ}_{\{ A . y \}} ( {Sum}_{\{ A . x \}}^{\{ z \}} , {ρ}_{A .} ( A ) )$$

In the preferred embodiment this corresponds to an executable S-expression
(AGGREGATE (PREFIX A “A”) (COMBINE-AGG (SUM A.x z)) #(A.y))

In Natural Algebra we define grouping and aggregation as a natural union over tuples across the domain of the grouping sub-header:

$${Ξ}_{G} ( {F}_{X}^{Z} , A ) {=}^{Def} {\sum }_{t ∈ D o m ( G )} \{ {F}_{X}^{Z} ( A t ) \cdot t \} \cdot I ( A t )$$

where the scalar function I(A [symbol] t) returns 0 if the argument k-relation is empty, and 1 otherwise. The dot operator · inside the braces denotes tuple multiplication by a tuple with non-overlapping header. The same operator outside the braces is scaling of a k-relation with 0 or 1 multiplier. Aggregate function F_{X}^{Z} produces a tuple with header Z for each group A [symbol] t and depends only on the values for attributes X in the group.

While the domain Dom(G) is typically infinite, for any finite k-relation A there is a finite number of non-empty groups A [symbol] t, so the operator is always computable. In some of the embodiments, the implementation of AGGREGATE maintains a hash-table, where sub-tuples t serve as keys, and incrementally computed values of aggregate function F_{X}^{Z} as values. Tuple t is iterated across the distinct set of Π_{G}(A), thus resulting in only non-empty groups A [symbol] t.

Query from this example can be expressed in as

$$Q = {\sum }_{t ∈ D om ( \{ y \} )} \{ {Sum}_{\{ x \}}^{\{ z \}} ( A t ) \cdot t \} \cdot I ( A t )$$

so that for a k-relation

$$A = \begin{matrix}x & y & \# \\ 1 & 2 & 1 \\ 2 & 2 & 1 \\ 3 & 3 & 2\end{matrix}$$

the domain Dom({y}) might be infinite, depending on the type of the column y, but the only tuples from it, which would produce non-empty groups are [symbol] y→2 [symbol] and [symbol] y→3 [symbol] .

Aggregate function Sum_{{x}}^{{z}} is defined as:

$${Sum}_{\{ x \}}^{\{ z \}} ( A ) {=}^{Def} 〈 z \to \{ \begin{matrix}{\sum }_{u ∈ A} x ( u ) \cdot {k}_{A} ( u ) , & A \neq {⌀}_{H ( A )} \\ Null , & A = {⌀}_{H ( A )}\end{matrix} 〉$$

which would produce resulting tuples [symbol] y→2, z→3 [symbol] and [symbol] y→3, z→6 [symbol] .

An important particular case is aggregation without grouping. In SQL such query would be expressed as
SELECT SUM (x) AS z FROM A

However, it's not the same thing as grouping on no attributes Ξ_{∅}, since the above SQL query is guaranteed to produce at least one tuple, whereas Ξ_{∅} operator would return an empty result on empty input.

Instead, the latter query would be translated to Natural Algebra as a direct call to the aggregate function:

$${Q}^{′} = {Sum}_{\{ A . x \}}^{\{ z \}} ( {ρ}_{A .} ( A ) )$$

where the definition of Sum_{{x}}^{{z}} takes care of the case where input is empty, emulating the standard SQL behavior.

### Example 9. Multi-Column Aggregation

Another example of queries which typically lack formalization in the relational database theory is aggregation applied to multiple columns, also expressions under the aggregate function calls and across the results of aggregate functions. The following query has all these features:
SELECT y, SUM (x*z) AS u, MAX (x)-MIN (x) AS v FROM A GROUP BY y

It translates to the Natural Algebra as

$$Q = {Π}_{\{ A . y , u , v \}} ( {Ξ}_{A . y \}} ( {Sum}_{\{ \_ aa 1 \}}^{\{ u \}} \cdot {Max}_{\{ A . x \}}^{\{ \_ a 2 \}} \cdot {Min}_{\{ A . x \}}^{\{ \_ a3 \}} , {ρ}_{A .} ( A ) \{ \_ aa 1 = A . x \cdot A . z \} ) \{ v = \_ a 2 - \_ a 3 \} )$$

where the first argument to Ξ is a vertical composition of the standard single-column aggregate functions. The combined aggregate function Sum_{{_aa1}}^{{u}}·Max_{{A.x}}^{{_a2}}·Min_{{A.x}}^{{_a3}} produces a tuple with header {u,_a2,_a3}, using the attributes {_aa1, A.x} from a k-relation which is the second argument to Ξ.

Any embodiment performing the translation of such query to Natural Algebra will need to introduce the intermediate computed attributes, both inside the argument k-relation, and outside the Ξ operator. The algebraizer in the preferred embodiment uses generated identifiers starting with underscore and ‘a’ for the results of the aggregate functions or with ‘aa’ for the arguments to aggregate functions. The projection to the set of columns explicitly mentioned in SELECT clause is added on top of the expression—otherwise _a2 and _a3 would also appear in the result.

The executable S-expression in the preferred embodiment demonstrates the usage of COMBINE-AGG macro, utilizing the built-in aggregate functions such as SUM, MAX, and MIN by supplying them with argument and result attributes, and combining them into a single multi-column aggregate function:

```
(PROJECT (N-JOIN (AGGREGATE (N-JOIN (PREFIX A “A”)
        (EXTEND _aa1 (NP.* A.x A.z)))
      (COMBINE-AGG (SUM _aa1 u))
          (MAX A.x _a2)
          (MIN A.x _a3))
      #(A.y))
    (EXTEND v (NP.- _a2 _a3)))
  #(A.y u v))
```

### Example 10. Removal of Duplicates

Removal of duplicates (the distinct operator) is common in relational databases, especially in situations where multisets might be produced, e.g. due to a projection:
SELECT DISTINCT y FROM A

This translates to Natural Algebra as

$$Q = ‖ {Π}_{\{ A . y \}} ( {ρ}_{A .} ( A ) ) ‖$$

which is represented as an executable S-expression in the preferred embodiment:
(DISTINCT (PROJECT (PREFIX A “A”) #(A.y)))

The distinct operator ∥⋅∥ is a particular case of grouping and aggregation, where grouping is performed on all attributes of the argument k-relation (as specified by the projection in our example), and the aggregate function is the constant empty tuple [symbol] [symbol] :

$$‖ A ‖ {=}^{Def} {Ξ}_{H ( A )} ( 〈 〉 , A )$$

Depending on the internal implementation of k-relation, the implementation of distinct operator might be different in different embodiments. If, for example, k-relations are always internally represented as sets of unique tuples with multiplicity value attached to each of them, the distinct operator would simply clone a k-relation and set multiplicities to 1. Other embodiments might use hash tables, or hash-table based stream windows to accommodate distinct over streaming k-relations, etc.

### Example 11. Set Operations

Most query languages incorporate both set and multiset semantics, switching between them in a number of explicit and implicit ways. One explicit way to switch to the set semantics is the distinct operator in SQL. Some operations, such as UNION, INTERSECT, and EXCEPT are designed to operate on sets of tuples with matching headers, and produce sets of tuples. The translation of such operations to Natural algebra involves (a) inserting distinct operator around the arguments or result, and (b) checking that the headers of the argument relations are union-compatible.

The notion of union-compatible does not depend on the column names, but depends on the implicit order of the attributes in each header, and their data types. We discuss the order in the following notes, so far we assume that we try to ‘cast’ one k-relation to the header of another.

Operator Cast_{\dot{H}(A)}(B) would assume there are ordered headers \dot{H}(A)= [symbol] a₁, . . . ,aₙ [symbol] and \dot{H}(B)= [symbol] b₁, . . . ,bₙ [symbol] with the same length n, and the domains of the respective attributes either agree

$$∀ i : D om ( {a}_{i} ) = D om ( {b}_{i} )$$

or (optionally, in some embodiments), there exists a wider domain \tilde{D}ᵢ containing the original ones:

$$∀ i : ∃ {\tilde{D}}_{i} ( D o m ( {a}_{i} ) ⊆ {\tilde{D}}_{i} ⋀ Dom ( {b}_{i} ) ⊆ {\tilde{D}}_{i} )$$

If these conditions hold, the result of Cast_{\dot{H}(A)}(B) operator is k-relation B with header substituted to \dot{H}(A):

$${Cast}_{\dot{H} ( A )} ( B ) {=}^{Def} {ρ}_{\dot{H} ( B ) \to \dot{H} ( A )} ( B )$$

If wider domains \tilde{D}ᵢ were derived for some of the attributes aᵢ∈\dot{H}(A), the domain of such attribute in the resulting header would be set to \tilde{D}ᵢ.

Now, consider an SQL query
SELECT * FROM A UNION SELECT * FROM B
   which translates to Natural Algebra as

$$Q = ‖ {ρ}_{A .} ( A ) + {Cast}_{A . \dot{H} ( A )} ( B ) ‖$$

or to the following executable S-expression in the preferred embodiment:
(DISTINCT (N-UNION (PREFIX A “A”) (CAST B (H-PREFIX (H A) “A”))))

The multiset-based SQL counterpart of it would use UNION ALL instead:
SELECT * FROM A UNION ALL SELECT * FROM B
   whose translation would not contain the distinct operator:

$$Q = {ρ}_{A .} ( A ) + {Cast}_{A . \dot{H} ( A )} ( B )$$

or to the following executable S-expression in the preferred embodiment:
(N-UNION (PREFIX A “A”) (CAST B (H-PREFIX (H A) “A”)))

Similarly, set-based INTERSECT operator in SQL, as in
SELECT * FROM A INTERSECT SELECT * FROM B
   would translate to Natural Algebra as a natural join of the distinct views of the corresponding k-relations:

$$Q = ‖ {ρ}_{A .} ( A ) ‖ ‖ {Cast}_{A . \dot{H} ( A )} ( B ) ‖ = ‖ {ρ}_{A .} ( A ) {Cast}_{A . \dot{H} ( A )} ( B ) ‖$$

or, to an executable S-expression in the preferred embodiment:
(DISTINCT (N-JOIN (PREFIX A “A”) (CAST B (H-PREFIX (H A) “A”))))

Finally, EXCEPT operator in SQL denotes the set difference of the results of two queries with matching headers:
SELECT * FROM A EXCEPT SELECT * FROM B

The set difference is Natural algebra is defined on the distinct views as a subtraction (i.e. natural union with the negated second argument) of the left k-relation and the set intersection of both:

$$Q = ‖ {ρ}_{A .} ( A ) ‖ - ‖ {ρ}_{A .} ( A ) {Cast}_{A . \dot{H} ( A )} ( B ) ‖$$

This corresponds to an executable S-expression in the preferred embodiment

```
(N-UNION (DISTINCT (PREFIX A “A”)
  (N* −1
    (DISTINCT (N-JOIN (PREFIX A “A”)
      (CAST B (H-PREFIX (H A) “A”))))))
```

where N* operator denotes a scalar multiplication of a k-relation.

### Note on the Original Order of Attributes

So far we were regarding headers of k-relations as unordered sets. However, the following simple rules provide an order of attributes, which is compatible with common SQL ordering for the queries translated so far:
1) Any stored k-relation A has a user-specified ordered header \dot{H}(A)
2)

$$\dot{H} ( A B ) {=}^{Def} \dot{H} ( A ) \vert ( \dot{H} ( B ) \backslash H ( A ) )$$

where | is a vector concatenation operator, and set difference \ of a vector and a set produces a sub-vector.
3)

$$\dot{H} ( A + B ) {=}^{Def} \dot{H} ( A ) \backslash ( H ( A ) \backslash H ( B ) )$$

4) The header of a projection is defined explicitly (as in the SELECT clause of an SQL query):

$$\dot{H} ( {Π}_{\dot{X}} ( A ) ) {=}^{Def} \dot{X}$$

5) The order of vertical composition of aggregate functions is specified by a query:

$$\dot{H} ( {F}_{Y}^{\dot{Z}} \cdot {K}_{U}^{\dot{V}} ) {=}^{Def} \dot{Z} \vert \dot{V}$$

6) The grouping attributes precede the attributes resulting from the aggregate function:

$$\dot{H} ( {Ξ}_{\dot{G}} ( {F}_{Y}^{\dot{Z}} ) ) {=}^{Def} \dot{G} \vert \dot{Z}$$

Note that these rules effectively break the commutativity of tuple join, natural join, and natural union operations, that's why in Natural Algebra we treat headers as unordered sets of attributes. All transformation rules for Natural Algebra expressions and any cost-based query optimizer (whose task is to re-order the join operands) should still treat these operations as commutative.

In order for set operations from Example 11 to be both SQL-compliant and independent on the join order chosen by optimizer, the header of each operand to a set operation needs to be computed first based on the ‘most direct’ translation, preserving the user specified join and projection order.

For example, an SQL query
SELECT * FROM A UNION ALL SELECT * FROM B JOIN C ON B.x=C.y
   would translate to:

$$Q = {ρ}_{A .} ( A ) + {Cast}_{A . \dot{H} ( A )} ( {{ρ}_{B .} ( B )}_{〈 B . x 〉} {〈 y 〉}_{} {ρ}_{C .} ( C ) )$$

Before making any further transformations, we memorize the user-specified ordered header of the right operand to UNION ALL:

$$\dot{X} = \dot{H} ( {{ρ}_{B .} ( B )}_{〈 x 〉} {〈 y 〉}_{} {ρ}_{C .} ( C ) ) = B . \dot{H} ( B ) \vert C . \dot{H} ( C )$$

If any expression transformations change the join order, we will still use the original order of attributes specified by \dot{X} for the purpose of Cast operator.

### Example 12. Subquery as a Table

Most query languages provide some degree of composability, allowing a query to refer to the result of another query. In SQL, this is done either by view definitions and usage
CREATE VIEW C AS SELECT * FROM B WHERE y>0
SELECT * FROM A JOIN C ON A.x>C.y
   or with a subquery in FROM clause:
SELECT * FROM A JOIN (SELECT * FROM B WHERE y>0) As C ON A.x>C.y

Both cases are equivalent, and would translate to Natural Algebra as

$$Q = {ρ}_{A .} A {A . x > C . B . y}_{} {ρ}_{C .} ( {ρ}_{B .} ( B ) \{ B . y > 0 \} )$$

or, as an executable S-expression in the preferred embedding:

```
(N-JOIN (E-JOIN (PREFIX A “A”)
    (PREFIX (N-JOIN (PREFIX B “B”)
      (FILTER (NP.> B.y 0))) “C”)
    #( ) #( ))
  (FILTER (NP.> A.x C.B.y)))
```

Here the expression ρ_{B.}(B) [symbol] {B.y>0} is the translation of the subquery, which in the host query receives alias C (translated to prefix C.), and participates in a theta-join.

Natural Algebra is ultimately composable, allowing any kind of k-relation expressions in each place where a k-relation is expected. For this reason, the attribute prefixes are allowed to ‘stack’ one before the other.

### Example 13. Correlated (Lateral) Subqueries

Relational query languages, such as SQL, allow greater interconnectedness among the query parts than simple context-free composability. Correlated subqueries rely on the variable bindings of the host query-much like the generated sets in Natural Algebra rely on the variable bindings of the finite k-relations they are joined with. Correlated subqueries are common in filters (as shown in the following examples), but some dialects of SQL, such as PostgreSQL, allow correlated table-valued subqueries directly in the FROM clause-so called LATERAL subqueries:
SELECT * FROM A, LATERAL (SELECT * FROM B WHERE A.x>y) AS C

Translating this query to Natural Algebra involves a predicate lifting technique. The Cartesian product from in the host query effectively gets joined with the predicate moved from the subquery, and becomes a theta-join:

$$Q = {ρ}_{A .} ( A ) \times {ρ}_{C .} ( B ) \{ A . x > C . y \}$$

or, as an executable S-expression in the preferred embodiment

(N-JOIN (E-JOIN (PREFIX A “A”) (PREFIX B “C”) #( ) #( ))
(FILTER (NP.> A.x C.y)))

which is quite similar to the theta-join from the Example 7.

### Example 14. Correlated Aggregate Subqueries

A different technique is needed to translate the following correlated aggregate subquery
SELECT * FROM A JOIN LATERAL (SELECT SUM(y) AS z FROM B WHERE A.x>y) AS C
WHERE A. w>0

If the condition in the subquery were dependent on a grouping variable, we could have used the same predicate lifting technique as in the previous example. However, here variable y cannot be accessible outside the subquery. So in order to evaluate the condition dependent both on A.x and y, we need to instead bind A.x inside the subquery. This is achieved by the scaffolding technique:

$$Q = ( {ρ}_{A .} ( A ) \{ A . w > 0 \} ) {\times }^{C .} {Ξ}_{\{ A . x \}} ( {Sum}_{\{ B . y \}}^{\{ z \}} , \\ {ρ}_{B .} ( B ) ‖ {Π}_{\{ A . x \}} ( {ρ}_{A .} ( A ) ) ‖ \{ A . x > B . y \} ) \{ A . x = C . A . x \}$$

Here the subquery is joined with the so-called finite scaffold ∥Π_{{A.x}}(ρ_{A.}(A))∥ of the remaining part of the outer query that produces a superset of all the bindings which A.x would receive. The scaffold variable A.x also becomes a grouping variable, and a separate group is generated for each such binding. Then, after the Cartesian product is formed, only those bindings which correspond to the actual bindings of A.x in the host query are retained.

The above is the ‘compositional’ role of the finite scaffold, which makes it possible to compute every finite Natural Algebra subexpression in those embodiments which allow only context-free compositionality.

In different embodiments, the implementations of the grouping and aggregation Ξ operator might be different. In particular, if a grouping variable is bound by a join where the result of Ξ participates, the grouping may be limited to only those bound values, effectively binding the grouping variable inside the under-aggregate expression. Since the finite scaffold ∥Π_{{A.x}}(ρ_{A.}(A))∥ guarantees a superset of such bindings, it can be safely omitted from the under-aggregate expression. The simplified equivalent

$$Q = ( {ρ}_{A .} ( A ) \{ A . w > 0 \} ) {ρ}_{C .} ( {Ξ}_{\{ A . x \}} ( {Sum}_{\{ B . y \}}^{\{ z \}} , {ρ}_{B .} ( B ) \{ A . x > y \} ) )$$

This, however, is not a compositionally computable Natural Algebra expression, and would only work in those embodiments which offer the said optimization for Ξ. Moreover, they should formally allow a variable which is not bound by any finite k-relation under the aggregate operator to be used as a grouping attribute.

### Example 15. Existence Subqueries

Subqueries can also be found in conditions, used either with quantifiers, or returning a single value (Example 19 below). The simplest case is the existence quantifier, acting as a logical expression:
SELECT * FROM A WHERE EXISTS (SELECT * FROM B WHERE A.x>y)

The check of whether the result of the correlated subquery is empty acts as a filter for the tuples from A:

$$Q = {ρ}_{A .} ( A ) \{ ∃ ( {ρ}_{B .} ( B ) \{ A . x > B . y \} ) \}$$

The logical predicate ∃ is true, if the Natural Algebra expression under it is non-empty, and false otherwise. The whole term {∃(ρ_{B.}(B) [symbol] {A.x>B.y})} is a generated set with header {A.x}, computable only if {A.x} is bound. The preferred embodiment defines the SQ-EXISTS form to directly reflect the existence quantifier and its dependencies:

```
(N-JOIN (PREFIX A “A”)
  (FILTER (SQ-EXISTS (A.x)
    (N-JOIN (PREFIX B “B”)
      (FILTER (NP.> A.x B.y))))))
```

with the first argument to SQ-EXISTS being the list of the attributes which need to be bound for evaluating it, and the second argument is the Natural Algebra expression under the quantifier.

This is, however, just the most direct translation. Taken separately, a filter with existence quantifier corresponds to the semijoin operator in relational algebra, and a filter with negated existence quantifier corresponds to antijoin. Natural Algebra defines semijoin [symbol] and antijoin [symbol] operators:

$$A B {=}^{Def} A ‖ {Π}_{H ( A )} ( B ) ‖ \\ A B {=}^{Def} A - A B$$

and the query from this example can be rewritten as

$$Q = {ρ}_{A .} ( A ) ( {ρ}_{B .} ( B ) \{ A . x > B . y \} )$$

Similarly to the previous example, such Natural Algebra expression requires that the implementation of semijoin [symbol] effectively passes the bindings for A.x from the left operand into the right, just like the natural join [symbol] does. Otherwise, if the implementation of semijoin requires context-free computability of both arguments, or if semijoin is rewritten according to its definition to be executed via projection and distinct, the right argument (ρ_{B,}B [symbol] {A.x>B.y}) is effectively infinite and cannot be computed.

To resolve this problem, a similar scaffolding technique can be applied:

$$Q = {ρ}_{A .} ( A ) ( {ρ}_{B .} ( B ) ‖ {Π}_{\{ A . x \}} ( {ρ}_{A .} ( A ) ) ‖ \{ A . x > B . y \} )$$

The finite scaffold ∥Π_{{A.x}}(ρ_{A.}(A))∥ produces all possible bindings directly for A.x. As this is the only common attribute among the left and right parts of semijoin, those bindings that pass the test A.x>B.y with at least one of the tuples from B appear in the result of the semijoin. Hence the equivalence to the original translation.

Example 16. Subqueries with ANY Quantifier

Let's consider a subquery with ANY quantifier, as in
SELECT * FROM A WHERE A.x > ANY (SELECT y FROM B)

We do not need another quantifier to represent ANY in the Natural Algebra, as this query literally means “select those rows from table A where A.x is greater than at least one y from table B”. Hence the translation, based on existence (non-emptiness) of a certain selection from B:

$$Q = {ρ}_{A .} ( A ) \{ ∃ ( {ρ}_{B .} ( B ) \{ A . x > B . y \} ) \}$$

which repeats the Natural Algebra translation from the previous example. Those queries are equivalent indeed, and the rewrites from the previous example are applicable. The key feature here is that the otherwise ‘uncorrelated’ subquery Π_{{B.y}}(ρ_{B.}(B)) becomes correlated, once extended by the filter {A.x>B.y} translating the condition around the ANY quantifier. We also do not keep projection under the existence quantifier—the only role of the projection in the SQL query was to point to the particular column to compare with.

The full list of Natural Algebra operators which can be safely dropped directly under existence quantifiers includes projection, extension, any join with many-to-at-least-one guarantee, renaming and prefixing, Cartesian product if the other argument is known to be non-empty, also left, right and full outer join (as defined below in Example 20), distinct, aggregation and grouping.

SQL also supports a negated version of ANY:
SELECT * FROM A WHERE NOT A.x ANY (SELECT y FROM B)
   meaning, literally “select those rows from table A where there is no such row in B that A.x is greater than B.y”, or equivalently but with a greater risk of ambiguity in English: “select those rows from table A where A.x is not greater than any y from table B”. Such query is translated with a negation of the existence quantifier:

$${Q}^{′} = {ρ}_{A .} ( A ) \{ ¬ ∃ ( {ρ}_{B .} ( B ) \{ A . x > B . y \} ) \}$$

or, as an S-expression in the preferred embodiment,

```
(N-JOIN (PREFIX A “A”)
  (FILTER (NOT (SQ-EXISTS (A.x)
    (N-JOIN (PREFIX B “B”)
      (FILTER (NP.> A.x
        B.y)))))))
```

This translation can be rewritten to antijoin, as shown in the previous example:

$${Q}^{′} = {ρ}_{A .} ( A ) ( {ρ}_{B .} ( B ) ‖ {Π}_{\{ A . x \}} ( {ρ}_{A .} ( A ) ) ‖ \{ A . x > B . y \} )$$

or, more briefly:

$${Q}^{′} = {ρ}_{A .} ( A ) ( {ρ}_{B .} ( B ) \{ A . x > B . y \} )$$

if the finite scaffold ∥Π_{{A.x}}(ρ_{A.}(A))∥ is not required by the particular embodiment.
Example 17. Subqueries with IN Quantifier

Most query languages, including SQL, allow providing explicit bindings for a certain variable, for example
SELECT * FROM A WHERE A.x IN (1, 3, 5)
   which translates to Natural Algebra expression with a constant k-relation:

$$Q = {ρ}_{A .} ( A ) \{ 〈 x \to 1 〉 , 〈 x \to 3 〉 , 〈 x \to 5 〉 \}$$

or to an S-expression in the preferred embodiment, using COLUMN constructor:
(N-JOIN (PREFIX A “A”) (COLUMN x (1 3 5)))

However IN can be also used to introduce a single-column subquery:
SELECT * FROM A WHERE A.x IN (SELECT y FROM B)

This is equivalent to using ANY quantifier with equality:
SELECT * FROM A WHERE A.x=ANY (SELECT y FROM B)
   which translates to Natural Algebra similarly to what was shown in the previous example:

$$Q = {ρ}_{A .} ( A ) \{ ∃ ( {ρ}_{B .} ( B ) \{ A . x = B . y \} ) \}$$

or, to an executable S-expression in the preferred embodiment:

```
(N-JOIN (PREFIX A “A”)
  (FILTER (SQ-EXISTS (A.x)
    (N-JOIN (PREFIX B “B”)
    (FILTER (EQUAL A.x B.y))))))
```

This translation can also be rewritten to semijoin.

Example 18. Subqueries with ALL Quantifier

The following SQL query can be phrased in English as “select rows from A where A.x is not greater than all y values in B”:
SELECT * FROM A WHERE NOT A. x>ALL (SELECT y FROM B)

Though given English phrasing may sound ambiguous, the SQL standard defines this as equivalent to “select rows from A where A.x is not greater than at least one y value in B”:
SELECT * FROM A WHERE A.x <=ANY (SELECT y FROM B)
   which is now using ANY quantifier with the negated condition, and translates to Natural Algebra accordingly:

$$Q = {ρ}_{A .} ( A ) \{ ∃ ( {ρ}_{B .} ( B ) \{ A . x \leq B . y \} ) \}$$

which can be further rewritten to semijoin.

An equivalent S-expression in the preferred embodiment would be

```
(N-JOIN (PREFIX A “A”)
  (FILTER (SQ-EXISTS (A.x)
    (N-JOIN (PREFIX B “B”)
    (FILTER (NP .<= A.x B.y))))))
```

Similarly, a non-negated case of ALL quantifier, “select rows from A where A.x is greater than all y values from B”:
SELECT * FROM A WHERE A.x>ALL (SELECT y FROM B)
   is defined in SQL as equivalent to the negated case with ANY quantifier, and the negated predicate-“select rows from A for which there is no such y value in B that A.x is not greater than y”:
SELECT * FROM A WHERE NOT A.x<=ANY (SELECT y FROM B)
   which also translates to Natural Algebra, as shown in the Example 16.

$$Q = {ρ}_{A .} ( A ) \{ ¬ ∃ ( {ρ}_{B .} ( B ) \{ A . x \leq B . y \} ) \}$$

and can be accordingly rewritten to antijoin.

An equivalent S-expression in the preferred embodiment would be

```
(N-JOIN (PREFIX A “A”)
  (FILTER (NOT (SQ-EXISTS (A.x)
    (N-JOIN (PREFIX B “B”)
      (FILTER (NP.<= A.x
        B.y))))))
```

### Example 19. Single-Value Subqueries

Sometimes the sole purpose of a subquery is to return a single value (i.e. exactly one result tuple mapping a single attribute). For example, a query “select all rows from A where x is greater than the maximum y value in B” can be formulated in SQL using a non-correlated single value subquery:
SELECT * FROM A WHERE A.x>(SELECT MAX (y) AS z FROM B)

Here the single-tuple result is guaranteed by a direct call to the aggregate function. The Natural Algebra translation would have to construct a relation from a single tuple, hence the braces around the call to Max:

$$Q = {ρ}_{A .} ( A ) \{ {Max}_{\{ B . y \}}^{\{ z \}} ( {ρ}_{B .} ( B ) ) * 1 \} \{ A . x > z \}$$

In SQL there is no concept of −∞, so MAX aggregate function would return Null if table B is empty. This behavior is also emulated by the definition of Max_{{z}}^{{z}} in Natural Algebra (compare with definition of Sum_{{x}}^{{z}} in Example 8):

$${Max}_{\{ x \}}^{\{ z \}} ( A ) {=}^{Def} 〈 z \to \{ \begin{matrix}{max}_{u ∈ A} ( x ( u ) ) , A \neq {⌀}_{H ( A )} \\ Null , A = {⌀}_{H ( A )}\end{matrix} 〉$$

A different situation is when single-tuple result is not guaranteed by the subquery expression, for example:
SELECT * FROM A WHERE A.x>(SELECT y FROM B WHERE w>10)

Here the existence and uniqueness of the result from the subquery Π_{{y}}(B [symbol] {w>10}) is a kind of external knowledge or promise which needs to be verified at run time. All relational databases which support SQL would throw a run-time error if the subquery in this example returns more than one tuple, and would effectively compare A.x to Null if the subquery result is empty.

The Natural Algebra translation of the above SQL query, in the most general case, is:

$${Q}^{′} = {ρ}_{A .} ( A ) ( {ρ}_{B .} ( B ) \{ B . w > 10 \} ) \{ A . x > B . y \}$$

The key feature in this translation is a natural join [symbol] with many-to-at-most-one guarantee. The same guarantee takes place when, for example, joining on a foreign key.

Embodiments which aim to fully simulate SQL semantics with respect to single-value subqueries will need to validate this guarantee on the actual data, and throw a run-time error if this guarantee is not fulfilled.

The preferred embodiment implements this run-time check with a function ASSERT-01, which returns the argument relation if its count is 0 or 1, and throws an error otherwise:

```
(N-JOIN (PREFIX A “A”)
  (ASSERT-01 (N-JOIN (PREFIX B “B”)
    (FILTER (NP.> B.w 10))))
  (FILTER (NP.> A.x B.y)))
```

### Note on Join Cardinality Guarantees

A stronger version of the above is many-to-one guarantee, a relationship between two k-relations which we denote using a graphical primitive [symbol] from ‘crow foot’ notation in the relational database modeling. With respect to join this takes place, for example, when joining on a non-nullable foreign key. Other cases are proven, including
extension: ∀A ∀X⊆H(A) ∀f(X) ∀y∉H(A): A [symbol] {y=f(x)}
aggregation and grouping: ∀A ∀X ∀F_{Y}²: A [symbol] Ξ_{X}(F_{Y}^{Z},A)
projection and distinct. ∀A ∀X: A [symbol] ∥Π_{X}(A)∥

Naturally, this guarantee includes the weaker ‘many-to-at-most-one’ guarantee used in the above example.

Different embodiments may use these kinds of guarantees for a number of purposes. For example, the corresponding physical implementation of the join operator might use such guarantee to avoid iterating on the respective operand past the first result tuple. At the same time, cost-based optimizer might find such guarantee useful for more accurate estimation of cardinalities of intermediate results (the stronger many-to-one guarantee offers more accurate estimates).

The many-to-one guarantee also offers a number of simplification opportunities for Natural Algebra expressions, such as

$$∀ A ∀ B : A B = A$$

$$∀ A ∀ B : A B = A ‖ B ‖$$

$$∀ A ∀ B ∀ X ⊆ H ( A ) : {\prod }_{X} ( A B ) = {\prod }_{X} ( A )$$

which are useful for optimization and for proving query equivalences.

### Example 20. Outer Joins

Standard relational algebra left, right, and full outer join operators are directly expressed in SQL, for example:
SELECT * FROM A LEFT JOIN B ON A.x =B.y

The result of the query would contain all columns from A and B, and all tuples from A listed at least once. If for certain tuple t∈A there are join-compatible tuples u∈B, all such tuple joins t·u will be listed, otherwise, tuple t will be extended with null values for attributes from the header of B.

There are simple ‘outer join’ analogs to natural join in Natural Algebra.

$$left join : A B {=}^{Def} A B + ( A B ) * {Null}_{H ( B ) \backslash H ( A )}$$

$$right join : A B {=}^{Def} A B + ( B A ) * {Null}_{H ( A ) \backslash H ( B )}$$

$$full outer join : A B {=}^{Def} A B + ( A B ) {Null}_{H ( B ) \backslash H ( A )} + ( B A ) {Null}_{H ( A ) \backslash H ( B )}$$

where Null_{X} is a single-tuple k-relation mapping all attributes in X to Null value.

However, these operators cannot be directly used to translate an SQL query, since there is no such thing as a ‘natural outer join’ in SQL. In practice, outer join analogs to equi-join and theta-join are useful, for example:

$$left equi - join : {A}_{\dot{X}} {\dot{Y}}_{} B {=}^{Def} {A}_{\dot{X}} {\dot{Y}}_{} B + ( A - ‖ {\prod }_{H ( A )} ( {A}_{\dot{X}} {\dot{Y}}_{} B ) ‖ ) {Null}_{H ( B )}$$

$$left theta - join : A {θ}_{} B {=}^{Def} A {θ}_{Q .}^{} B + ( A - ‖ {\prod }_{H ( A )} ( A {θ}_{} B ) ‖ ) {Null}_{H ( B )}$$

with other kinds of outer joins being defined via the inner versions of theta-and equi-join in the same manner, under the requirement of disjoint headers: H(A)∩H(B)=∅.

The query from this example would then simply translate to Natural Algebra as:

$$Q = {{ρ}_{A .} ( A )}_{〈 x 〉} {〈 y 〉}_{} {ρ}_{B .} ( B )$$

or, as an executable S-expression in the preferred embodiment:
(E-LEFT-JOIN (PREFIX A “A”) (PREFIX B “B”) #(x) #(y))
   where E-LEFT-JOIN form is defined as shown above, and is syntactically similar to E-JOIN.

### Example 21. Ordered K-Relations

Ordered k-relations can be modeled in Natural Algebra as a k-relation extended with order attribute i. An SQL query returning a sorted relation
SELECT * FROM A ORDER BY x ASC, y DESC

Translates to natural algebra using a sort operator Ψ:

$${Q}_{1} = Ψ ( {ρ}_{A .} ( A ) , 〈 A . {x}^{⋀} , A . {y}^{⋁} 〉 )$$

Here [symbol] A.x^{∧}, A.y^{∨} [symbol] is a sort-vector-a vector of attributes, where each attribute is annotated with either ascending ∧ or descending ∨ flag. The sort operator Ψ produces an ordered k-relation as specified by this sort-vector.

An ordered k-relation \dot{A} is a k-relation A where every tuple t∈A contains a special order attribute i(t). A sort-vector, formally, is either an empty vector, or any sort-vector Ÿ concatenated with an annotated attribute:

$$\ddot{X} {=}^{Def} \{ \begin{matrix}〈 〉 \\ \ddot{Y} \vert {a}_{i}^{⋀} \\ \ddot{Y} \vert {a}_{i}^{⋁}\end{matrix}$$

Header of sort-vector H(\ddot{X}) is a set of all attributes in \ddot{X}:

$$H ( 〈 〉 ) {=}^{Def} ∅ , H ( \ddot{Y} \vert {a}_{i}^{⋀} ) = H ( \ddot{Y} \vert {a}_{i}^{⋁} ) {=}^{Def} H ( \ddot{Y} ) ⋃ \{ {a}_{i} \}$$

The sort operator Ψ can be defined as a join:

$$Ψ ( A , \ddot{X} ) {=}^{Def} A \{ i ( {s}_{1} , … , {s}_{k} ) \}$$

where H(\ddot{X})={s₁, . . . ,sₖ}, and the function i(s₁, . . . ,sₖ) is any such function that satisfies the precedence condition [symbol] defined by \ddot{X} on the set of tuples:

$$i ( {s}_{1} ( t ) , … , {s}_{k} ( t ) ) \leq i ( {s}_{1} ( u ) , … , {s}_{k} ( u ) ) ⇔ {t \leq u}^{\ddot{X}}$$

Tuple t precedes tuple u according to the sort-vector \ddot{X}, given H(t)=H(u)⊇H(\ddot{X}):

$${t \leq u}^{\ddot{X}} {⇔}^{Def} \ddot{X} = 〈 〉 ⋁ ( \ddot{X} = \ddot{Y} \vert {a}_{i}^{⋀} ⋀ {t \leq u}^{\ddot{Y}} ⋀ ( {u \leq t}^{\ddot{Y}} ⇒ {a}_{i} ( t ) \leq {a}_{i} ( u ) ) ) ⋁ ⋁ ( \ddot{X} = \ddot{Y} \vert {a}_{i}^{⋁} ⋀ {t \leq u}^{\ddot{Y}} ⋀ ( {u \leq t}^{\ddot{Y}} ⇒ {a}_{i} ( u ) \leq {a}_{i} ( t ) ) )$$

this requires ≤ relationship to be defined within every domain Dom(aᵢ), aᵢ∈H(\ddot{X}).

For an empty sort-vector, thee precedence relationship holds for any pair of tuples, and order function i( ) can be any constant. However empty sort-vector does not allow eliminating the sort operator: Ψ(A, [symbol] [symbol] )≠A, a special order attribute is still attached to A.

### 3. Translating SQL queries to Natural Algebra

As the above examples have demonstrated, SQL functionality is totally covered by Natural Algebra, and every feature in SQL query has at least one Natural Algebra representation. For many features we have defined corresponding derived operators, based on natural join and/or natural union, hence the equivalent forms using only basic operators, or some intermediate derived ones. In this section we outline the process of obtaining a most direct Natural Algebra translation of an SQL query, which can be further transformed, as described in Section 4.

Though the translation methodology is presented here using SQL as an input query language, a person skilled in the art should be able to define a similar algebraization method for any other query language based on relational, object-relational, or graph semantics. Section 3.9 below gives an example of translating LINQ queries in a similar way.

### 3.1 Translating FROM Clause

We start building a Natural Algebra expression with translation Q_{FROM} of the FROM clause, treating different kinds of FROM-expressions, according to the following rules:
1) If a FROM-expression is an aliased table name, such as A AS A1, the translation is ρ_{A1.}(A)
2) If a FROM-expression is an unaliased table name, such as A, the translation still involves renaming:
ρ_{A.}(A)
3) If a FROM-expression is any kind of join of two FROM-expressions with join condition specified, the translation will introduce the theta-join version of the corresponding join operator (inner, left, right, full). For example, A LEFT JOIN B ON A.x=B.y would translate to

$${ρ}_{A .} ( A ) {A . x = B . y}_{} {ρ}_{B .} ( B )$$

Transforming a theta-join into equi-join is best expressed as a rule-based transformation:

$$A {}_{{\hat{k}}_{} {a}_{k} = {b}_{k}} B {\to }^{∀ k : {a}_{k} ∈ {H ( A )}_{⋀ {b}_{k}} ∈ H ( B )} {A}_{〈 {a}_{1} , … , {a}_{n} 〉} {}_{〈 {b}_{1 , … ,} {b}_{n} 〉} B$$

4) If a FROM-expression is a natural join, such as A NATURAL JOIN B, the translation would feature an equi-join with (ordered) set of common attributes on both sides:

$${{ρ}_{A .} ( A )}_{\dot{X}} {\dot{X}}_{} {ρ}_{B .} ( B )$$

where \dot{X}=\dot{H}(A)\dot{∩}\dot{H}(B) is a vector of common attributes, built from the ordered headers using a non-commutative vector-based version of set intersection:

$$\dot{X} \dot{⋂} \dot{Y} {=}^{Def} \dot{X} ∖ ( X ∖ Y )$$

In a schema-aware translation, header expression \dot{X} is a good candidate for partial evaluation during the query translation phase.
5) If FROM clause contains a list of comma-separated FROM-expressions, the translation of the FROM clause is the Cartesian product of translations of these expressions. For example, FROM A, B will be translated to

$${Q}_{F R O M} = {ρ}_{A .} ( A ) \times {ρ}_{B .} ( B )$$

### 3.2 Accommodating Query Parameters

If a query makes use of parameters, they are enumerated as p₁, . . . , pₘ attributes distinct from any other attributes in the query, and are represented by a special k-relation Par, H(Par)={p₁, . . . , pₘ}, which is guaranteed to contain single tuple and its values will be available at run-time just as values of any other k-relations. Par is joined with Q_{FROM} in order to obtain the full set of attributes available in the query:

$${Q}_{P A R} = Par {Q}_{FROM}$$

If there are no parameters used in the query, Q_{PAR}=Q_{FROM}

### 3.3 Translating WHERE Clause

In SQL queries WHERE clause contains a single Boolean expression P(X), dependent on attributes of the expression in FROM clause and query parameters. We can always directly map it to a filtering generated set joined with the translation of the FROM clause.

$${Q}_{WHERE} = {Q}_{P A R} \{ P ( X ) \}$$

and if there is no WHERE clause in the query, Q_{WHERE}=Q_{PAR}

However, conjunctive WHERE conditions are quite common, and it is sometimes useful to rewrite them into a set join of translations of conjunctive parts:

$$\{ P ( X ) ⋀ Q ( X ) \} ⟶ \{ P ( X ) \} \{ Q ( X ) \}$$

For example, a query containing
FROM A, B WHERE A.x=B.y AND A.z=?would at this stage of translation be represented by a fragment

$${Q}_{WHERE} = Par {ρ}_{A} . ( A ) {ρ}_{B} . ( B ) \{ A . x = B . y \} \{ A . z = {p}_{1} \}$$

and using also the transformation rule in section 3.1 this would be equivalent to a nested equi-join:

$${Q}_{WHERE} = Par {{ρ}_{A .} ( A )}_{〈 x 〉} {〈 y 〉}_{} {ρ}_{B .} ( B ) \{ A . z = {p}_{1} \} = {Par}_{〈 {p}_{1} 〉} {〈 A . z 〉}_{} ( {{ρ}_{A .} ( A )}_{〈 x 〉} {〈 y 〉}_{} {ρ}_{B .} ( B ) )$$

### 3.4 Translating SELECT Clause

In SQL queries SELECT clause corresponds to the projection operator in Natural Algebra. However, any scalar expression effectively produces new attributes, so such expressions are translated to the generated sets. The following translation rules apply, in order to obtain the translation Q_{SELECT}:
1) If SELECT clause only contains a star, e.g.
SELECT * FROM A
   the whole header of Q FROM translation is used in the projection:

$${Q}_{S E L E C T} = {Π}_{A . H ( A )} ( {ρ}_{A .} ( A ) )$$

If the Natural Algebra expression has no other attributes than those listed in the projection, the projection can removed, as specified by the following simplifying transformation rule:

$${\prod }_{X} ( A ) {⟶}^{H ( A ) ⊆ X} A$$

2) If SELECT clause contains a non-aliased attribute name, for example,
SELECT A.x FROM A
   this attribute is used in the projection on top of the translation so far, for example,

$${Q}_{S E L E C T} = {Π}_{\{ A . x \}} ( {ρ}_{A .} ( A ) ) .$$

3) If SELECT clause contains an aliased expression, such as
SELECT A.x+1 AS y FROM A
   a generated set is joined with the translation obtained so far, in this example

$${Q}_{WHERE} \{ y = A . x + 1 \}$$

This also applies to aliased expressions which consist of a single attribute.
4) If SELECT clause contains a non-aliased expression, the default unique alias is created, and the translation is then performed according to case (3) above. Different embodiments may have their own policies for generating default unique aliases. A practice which would be best compatible with modern relational DBMSs is to allow arbitrary strings as attribute (column) names, and use the original expression string, ‘A.x+1’ as an alias.
5) If SELECT clause contains DISTINCT keyword, the Distinct operator ∥⋅∥ is added on top of the projection, for example,
SELECT DISTINCT A.x, A.y FROM A
   is translated to
∥Π_{{A.x,A.y}}ρ(A)∥

### 3.5 Unqualified Attribute Resolution

In the SQL examples so far we always used attribute names qualified with table aliases or names (which are their implicit aliases), such as A.x, B.y. In a query where only a single table is referred in the FROM clause, this is obviously redundant, and forming an equivalent translation of a query with unqualified attributes is a trivial task. We would still translate a query
SELECT x, y FROM A
   as ∥Π_{{A.x,A.y}}ρ(A)∥ for consistency and composability reasons. However, a query
SELECT x, y FROM A, B
   requires a disambiguation step which needs to look at the schema, and either report an ambiguity, or transform unqualified attributes to the qualified ones, for example producing
SELECT A.x, B.y FROM A, B
   before any actual translation takes place.

### 3.6 Translating Set Operations

Example 11 from the previous section covers the technique that covers the set operations. At this point we have translation of at least two operand queries of a set operation, Q′_{SELECT} and Q″_{SELECT}, each having a projection operator on top, and we obtain Q′_{SETOP} by header-casting and combining these projections. If there are no set operations, Q_{SETOP}=Q_{SELECT}.

### 3.7 Translating ORDER BY Clause

Example 21 from the previous section illustrates the translation of the ORDER BY clause, by inserting the sort operator Ψ and forming the order-vector \ddot{X} in all elementary cases. Here we show how does it compose with other SQL query features.

In a query with no set operations, the sort operator is inserted just under the projection which is introduced by SELECT clause, but above any joins with generated sets, which are introduced there also. This way sort operator Ψ has access to both aliases and any aliased attributes, including those not listed in SELECT clause. For example, the following two queries are equivalent:
SELECT a AS x FROM A ORDER BY a
and
SELECT a AS x FROM A ORDER BY X
   while the result of either query will only contain column x:

$${Q}_{ORDER} = {Π}_{\{ x \}} ( Ψ ( {ρ}_{A .} ( A ) \{ x = A . a \} , 〈 A . {a}^{⋀} 〉 ) ) = {Π}_{\{ x \}} ( Ψ ( {ρ}_{A .} ( A ) \{ x = A . a \} , 〈 {x}^{⋀} 〉 ) )$$

However, in a query with set operations, projections are needed to form the compatible headers. For example,
SELECT a AS x, b AS y FROM A UNION SELECT a, b FROM B ORDER BY X
   is a valid SQL query, while the same query ordering by a would not be valid, since ORDER BY has no access to the projected-out attributes of either UNION branch.

This fact agrees with our technique for translating set operations. The translation of the above query would simply put the sort operator on top of the translation Q_{SETOP}:

$${Q}_{ORDER} = Ψ ( ‖ {Π}_{\{ x , y \}} ( {ρ}_{A .} ( A ) \{ x = A . a \} \{ y = A . b \} ) + {Cast}_{〈 x , y 〉} ( {Π}_{\{ B . a , B . b \}} ( {ρ}_{B .} ( B ) ) ) ‖ , 〈 {x}^{⋀} 〉 )$$

### 3.7 Translating Aggregate Queries

An aggregate query in SQL is a query which contains at least one call to an aggregate function, either in SELECT, HAVING, or ORDER BY clauses. The set of aggregate functions is either limited to the built-in ones, and includes SUM, COUNT, MIN, MAX, AVG, or relies on an extensibility mechanism. An aggregate query may or may not have GROUP BY and/or HAVING clauses.

To illustrate the translation steps, we will follow an example, similar to Example 9 in the previous section, but featuring HAVING and ORDER BY clauses:
SELECT y, SUM (x*z) AS u FROM A GROUP BY y HAVING MIN (x)>5 ORDER BY MAX (z) DESC
   Step 1. Building list of aggregates

In order to determine if a given SQL query is an aggregate query, the following technique is used in our system: each scalar expression in SELECT, HAVING, and ORDER BY clauses is traversed in search for an aggregate function call. If such call is found, the expression under it is put in a list of aggregate calls, where each record [symbol] F, e, a [symbol] consists of such an expression e, the aggregate function F being called, and an explicit or generated alias a for this call. Our example query would produce the following list:

$$〈 Sum , A . x \cdot A . z , u 〉 , 〈 Min , A . x , \_a 2 〉 , 〈 Max , A . z , \_a 3 〉 .$$

The aggregate expressions in the query expressions are rewritten to the aliases from this list, so here is our example query after rewrite:
SELECT y, u FROM A GROUP BY Y HAVING _a2>5 ORDER BY _a3 DESC

If the list of aggregates is empty, given SQL query is not an aggregate query, and is translated normally, as described in parts 3.1-3.6 of this section.

### Step 2. Translating Inner Query

The translation of an aggregate query includes inner and outer Natural Algebra expressions, each having their own set of available attributes. The inner expression is formed by translating the query with original FROM and WHERE clauses, and where SELECT clause lists all the distinct under-aggregate expressions listed in the first step, with generated aliases added whenever the expression is not a single attribute. The inner query corresponds to our example:
SELECT x*z AS _aa1, x, z FROM A
   and translated to Natural Algebra as ρ_{A.}(A) [symbol] {_aa1=A.x·A.z}. The translation of the SELECT clause of the inner query introduces the generated sets for any expressions and aliases, but skips the projection, leaving all attributes from Q_{FROM} available in the query result.

With generated aliases for under-aggregate expressions are introduced in this step, the expressions in the list of aggregates are rewritten to these aliases, so the first record in the list changes:

$$〈 Sum , \_aa1 , u 〉 , 〈 Min , A . x , \_a2 〉 , 〈 Max , A . z\_a3 〉$$

### Step 3. Building a Compound Aggregate Function

No matter how many aggregate functions are involved in an SQL query, their computation needs to be done in one pass over the results of the inner query. The computation itself can thus be a compound aggregate function. It is easily built from the list of aggregates, which is rewritten during the previous step.

The results of single-column aggregate functions are single attribute tuples with unique headers, so a tuple join effectively concatenates them. Each aggregate function has a specification of its input and output attribute in the list of aggregates, so our example we obtain Sum_{{_aa1}}^{{u}}·Min_{{A.x}}^{{_a2}}·Max_{{A.z}}^{{_a3}}.

### Step 4. Translating Outer Query

The outer query consists of the original SELECT clause, rewritten at step 1, with HAVING condition in place of the WHERE clause, and any original ORDER BY clause. As a replacement for the FROM clause we use either a grouping and aggregation operator Ξ if there is a GROUP BY clause, or a direct application of our compound aggregate function to the result of the inner query. Such query is translated normally, as described in sections 3.1-3.6, and the complete translation is

$$Q = {Π}_{\{ A . y , u \}} ( Ψ ( {Ξ}_{\{ A . y \}} ( {Sum}_{\{ \_ aa 1 \}}^{\{ u \}} \cdot {Min}_{\{ A . x \}}^{\{ \_ a 2 \}} \cdot {Max}_{( A . z \}}^{\{ \_ a 3 \}} , {ρ}_{A .} ( A ) \{ \_aa1 = A . x \cdot A . z \} ) \{ \_a2 > 5 \} ) , 〈 {\_a3}^{⋁} 〉 ) )$$

If our example query had no GROUP BY clause (and consequently could not use y attribute in SELECT clause),
SELECT SUM (x*z) AS u FROM A HAVING MIN (x)>5 ORDER BY MAX (z) DESC the translation would contain such function application (effectively, a single-tuple k-relation), joined with the generated sets remaining in the rewritten SELECT clause of the outer query, sorted, and projected to the specified attributes:

$$Q = {Π}_{\{ u \}} ( Ψ ( {Sum}_{\{ \_ aa 1 \}}^{\{ u \}} \cdot {Min}_{\{ A . x \}}^{\{ \_ a 2 \}} \cdot {Max}_{( A . z \}}^{\{ \_ a 3 \}} ( {ρ}_{A .} ( A ) \{ \_aa1 = A . x \cdot A . z \} \{ \_a2 > 5 \} ) , 〈 {\_a3}^{⋁} 〉 ) )$$

Note that the call to aggregate function produces exactly one tuple, and the expression under the sort operator Ψ is either single-tuple or empty k-relation, so the sorting can be safely removed. This query is equivalent to one without ORDER BY clause.

### 3.8 Translating Subqueries

The spectrum of applicable techniques is illustrated in much detail in the examples 12-19 above, so here we provide a short summary.

1) In SQL subqueries may appear
in FROM clause, in which case they may feed multiple attributes into the host query;
in conditions with ANY/SOME/IN quantifiers, in which case they return a single column;
in scalar expressions, returning a single value;
as Boolean conditions with EXISTS/NOT EXSTS quantifiers, in which case only the emptiness or non-emptiness of their result matters.

2) There are correlated and uncorrelated subqueries. While the uncorrelated subqueries are straightforward to translate, thanks to the compositionality of Natural Algebra, correlated subqueries depend on the bindings of attributes in the host query, and require either certain rewrites during the translation (predicate lifting, finite scaffolding techniques shown in the examples), or an execution framework will allows passing the context down into the subexpressions being evaluated. We describe such an execution framework in Section 6.

### 3.9. Other Algebraizers

The steps described above are easily generalized to other query languages, for example, SPARQL and LINQ. The following example of LINQ query has obvious counterparts of FROM, WHERE, ORDER BY, and SELECT clauses, which are described above:

```
var result = (from p in Person
  where p.firstName == “Joe”
  orderby p.age
  select new { p.firstName, p.lastName, p.age })
```

Using the same approach, this query is translated to

$${Π}_{\{ p . firstName , p . lastName , p . age \}} ( Ψ ( {ρ}_{p .} ( Person ) \{ p . firstName = ' Joe ' \} , 〈 p . {age}^{⋀} 〉 ) )$$

Section 6 provides more examples of translating queries with object and graph semantics, featuring yet another input language-Starcounter QL, an object-oriented extension of SQL.

Natural Algebra is a common representation of database queries. Once a query is translated to Natural Algebra, it can be validated, optimized, and executed using the system and method defined in this disclosure.

### 4. Natural Algebra Transformation Rules

Most of the transformations of the Natural Algebra expressions including simplification, normalization, transformations between operator-rich and operator-homogenic forms, logical and physical optimization, can be expressed in a context-free way as transformation rules, and are the preferred way of transforming Natural Algebra expressions.

A transformation rule consists for input pattern, output pattern, applicability function, and value transformer function. If omitted, applicability function is constant true, and value transformer function is identity function.

### 4.1 Operator DEFINITIONS as TRANSFORMATION RULES

### Example 2 Mentions a Simple Transformation Rule

$${R}_{1} : {\prod }_{X} ( A ) ⟶ {∅}_{X} + A$$

with input pattern Π_{X}(A) and output pattern ∅_{X}+A corresponding to the definition of the projection operator. Any derived operator defined in this disclosure has at least one such rule, and the exhaustive application of this class of rules to any Natural Algebra expression results in operator-homogenic form of that expression, consisting only of natural join and natural union operators.

A reverse rule

$${R}_{2} : {∅}_{X} + {A}^{*} ⟶ {\prod }_{X} ( A )$$

would transform an expression towards an operator-rich form, by changing some of the natural union occurrences to projections. The star next to the symbol A means ‘match all the remaining arguments of the commutative and associative operator’. Otherwise, a combinatorial number of matches are possible, while only the fullest one makes practical sense.

Applying R₂ against an expression A₁+A₂+∩_{{x}}) would transform it into Π_{{x}}((A₁+A₂), and how the input pattern is matched is summarized by the following table:

| X | A* |
|---|---|
| {x} | A₁ + A₂ |

### 4.2 Simplification Rules

An example of a simplification rule

$${R}_{3} : {∅}_{X} {A}^{*} ⟶ {∅}_{X ⋃ H ( A )}$$

has the same feature, since natural join is also commutative and associative, and any single empty operand would make the result of the whole natural join empty.

Note that this kind of transformations can be performed both in schema-aware and schema-ignorant setting, i.e. whether header expressions are immediately evaluated to the sets of attributes, or retained in the symbolic form.

### 4.3 Logical-to-Physical Rewrites and Index Utilization

The note on join predicate rewrites after Example 7 given an example of logical-to-physical transformation, which can be expressed as a rule

$${R}_{4} : {A}^{*} B \{ x > y \} {⟶}^{x ∈ H ( A ) ⋀ {Range}^{y} ∈ Idx ( B )} A {Range}_{( - ∞ , x )}^{y} ( B )$$

where the applicability condition checks that the attributes used in inequality condition belong to the respective headers. Additionally, while A* pattern can match any ‘remaining’ part of the n-ary natural join, this rule only makes sense if B exposes a range index on attribute y, i.e. it is either a stored k-relation with such index defined, or is a projection/rename/union of k-relations having this property.

The set of physical indexes Idx(A) available for any subexpression A is propagated through these operators, according to the following principles:
1) If A is a stored k-relation, Idx(A) is a list of indexes physically defined on it
2) For any index i^{a} on an attribute a: if i^{a}∈Idx(A) then i^{P.a}∈Idx(ρ_{P.}(A))
3) Idx(Π_{X}(A))=Idx(A), i.e. it is always possible to index a k-relation even if the respective attributes are later projected-out.
4) Idx(A+B)=Idx(A)∩Idx(B), i.e. a natural union exposes a set of indexes which present in both if its arguments.

These principles can be formulated as transformation rules, in order to bring the physical access operator Range^{y} closer to the stored k-relation, while transforming the query in Example 7:

$$Q = {ρ}_{A .} ( A ) {ρ}_{B .} ( B ) \{ A . x > B . y \} {=}^{{R}_{4}} {ρ}_{A .} ( A ) {Range}_{( - ∞ , A . x )}^{B . y} ( {ρ}_{B .} ( B ) ) {=}^{{R}_{5}} {=}^{{R}_{5}} {ρ}_{A .} ( A ) {ρ}_{B .} ( {Range}_{( - ∞ , A . x )}^{y} ( B ) )$$

where rule R₅ is formulated after the principle (2) above w.r.t. the Range^{y} index and physical access operator:

$${R}_{5} : {Range}_{( {y}_{min} , {y}_{max} )}^{P . y} ( {ρ}_{P .} ( A ) ) ⟶ {ρ}_{P .} ( {Range}_{( {y}_{min} , {y}_{max} )}^{y} ( A ) )$$

### 4.4. Recursive Computation of Sub-Expression Traits

The set of exposed physical indexes Idx(A) discussed above is an example of the physical trait which can be recursively computed from leaf to root. Other such examples would include expression's header H(A), positiveness A>0 (i.e. all tuple multiplicities are positive), distinctness guarantee (A=∥A∥), single-tuple guarantee (|A|=1), etc. In our framework this is an open set of attributes, which can be extended in conjunction to adding new transformation rules into the system.

Another class of traits are the contextual traits which needs to be propagated from root to leaves. Examples are a set of bound attributes ↓ Bound , or whether distinct operator is applied on top ↓∥⋅∥.

For example, the 75 ∥⋅∥ contextual trait is useful for transforming a disjunction of filters into a natural union. Under normal circumstances, where multiplicities of tuples do matter, such transformation includes a second-order term, which impacts the rule's usability, since it provides little simplification:

$${R}_{6} : \{ f ( X ) ⋁ g ( y ) \} ⟶ \{ f ( X ) \} + \{ g ( Y ) \} - \{ f ( X ) \} \{ g ( Y ) \} .$$

However, under the contextual trait of 75 ∥⋅∥, we have a true normalization/simplification rule:

$${R}_{7} : \{ f ( X ) ⋁ g ( X ) \} {⟶}^{↓ ‖ \cdot ‖} \{ f ( X ) \} + \{ g ( X ) \}$$

The same effect can be achieved by without introducing the 75 ∥⋅∥ contextual trait. An alternative set of rules would be

$${R}_{8} : ‖ \{ f ( X ) ⋁ g ( X ) \} ‖ ⟶ ‖ \{ f ( x ) \} + \{ g ( X ) \} ‖$$

and a number of bi-directional rules for propagating the distinct operator down and up, so that the input pattern of R₈ can be eventually matched:

$${R}_{9} : ‖ A B ‖ ⟷ ‖ A ‖ ‖ B ‖$$

$${R}_{10} : ‖ A + ‖ B ‖ ‖ {⟷}^{A > 0 ⋀ B > 0} ‖ A + B ‖$$

$${R}_{11} : ‖ {\prod }_{X} ( A ) ‖ {⟷}^{A > 0} ‖ {\prod }_{X} ( ‖ A ‖ ) ‖$$

Having the condition in R₇ formulated as a contextual trait not only reduces the number or rules which need to be added into the system, but more importantly, the amount of transformations needed to achieve the simplification expressed by the rule.

Transforming a query
SELECT DISTINCT * FROM A WHERE X=1 OR y=5
   originally translated as Q=∥ρ_{A.}(A) [symbol] {A.x=1∨A.y=5}∥ into Q⁽¹⁾=∥ρ_{A.}(A) [symbol] ({A.x=1}_{{A.x,A.y}}+{A.y=5}_{{A.x,A.y}})∥would either take a single R₇ transformation, or a sequence of \vec{R}₉, R₈, R₉ transformations. The practical gain of doing this transformation is applying the distributivity rule next:

$${R}_{12} : A ( B + C ) {⟷}^{H ( B ) ⋂ H ( A ) = H ( C ) ⋂ H ( A )} A B + A C$$

which would transform the Natural Algebra expression into

$${Q}^{( 2 )} = ‖ {ρ}_{A .} ( A ) \{ A . x = 1 \} + {ρ}_{A .} ( A ) \{ A . y = 5 \} ‖$$

which offers the potential for betted index utilization.

### 4.5 Rules Framework

Previously in this section only few examples of different transformation rules were presented, together with particular features of the rule application framework. This disclosure does not aim to present a full and exhaustive list of transformation rules, instead, it presents a framework were rules can be easily formulated, managed, and executed. A transformation rule is a machine-readable and executable interpretation of a mathematical fact about Natural Algebra, the properties of its basic and derived operators.

In any embodiment of the present invention a system (framework) for applying transformation rules would include the following components:
1) A system for computing certain traits of Natural Algebra subexpressions, optionally caching them on the expression subtrees, and invalidating this cache when the corresponding leaf-wise or root-wise nodes are transformed.

As an optimization, each trait may have its own invalidation logic, while headers H (A) are invariant under all valid Natural Algebra transformations, the inherent sorting order \ddot{s}(A) depends on the physical access operator (index) already chosen during the logical-to-physical transformation of the subexpressions. Similarly with contextual traits, while ↓∥⋅∥ is stable, the set of bound attributes ↓ Bound depends on the position of the current subtree in each n-ary join root-wise, and the attributes bound by the previous arguments to that n-ary join.
2) A representation of transformation rules, including their input and output patterns, applicability conditions and value transformation functions. Optionally, capability to name and group the rules into named classes.
3) An expression tree traversal algorithm, whether making complete traversal after each transformation, or, as optimization, marking the rules and parts of the expression tree which did not match and do not need to be examined again.
4) A mechanism to perform the transformation of expressions as specified by a given rule, optionally with logging, provenance recording, and backtracking capabilities.
5) A set of strategies or heuristics to guide the transformation process towards a desired goal. This is especially important in presence of bi-directional transformation rules, or when utilizing backtracking capabilities to navigate the graph of possible equivalent forms of a Natural Algebra expression.

The rules framework is where most of the query optimization takes place. Certain algebraization tasks also make use of this framework, as illustrated by the examples in the next section.

### 5. Starcounter QL Examples

### Example 22. Object References

Starcounter is multi-paradigm database, which allows querying stored classes using an extension of SQL language, here referred to as Starcounter QL.

In the view of Starcounter QL tables are classes, i.e. collections of instances (objects) with the same schema (set of fields). While one can select all field values from a certain class, using the SQL star syntax:
SELECT * FROM A
   one can also select objects directly from a class with a Starcounter QL query
SELECT A FROM A

While the first query selects tuples mapping each attribute of class A to its instance values, the second query returns tuples of width 1, containing objects.

In order to accommodate this dichotomy, we assume that every stored table (class) has special attribute with a reserved name oid, besides all other attributes (fields) defined by the user.

For convenience of translating SQL star-syntax queries, we define a start-header function H*(A). For a particular stored k-relation A, it would contain all its stored attributes except for the reserved oid attribute:

$$H * ( A ) = H ( A ) ∖ \{ oid \}$$

If an argument k-relation is the result of a Natural Algebra operation, it might contain no oid attributes, or might contain multiple oid attributes from different tables. The header H*(A [symbol] B) would filter out all such attributes from the result of a natural join:

$$H * ( A B ) = H ( A B ) ∖ \{ A . oid , B . oid \}$$

This approach allows translating the first query from this example as

$${Q}_{1} = {Π}_{A . H * ( A )} ( {ρ}_{A .} ( A ) ) ,$$

and the second query as

$${Q}_{2} = {Π}_{\{ A . oid \}} ( {ρ}_{A .} ( A ) ) .$$

Similarly, pairs of objects form A and B can be returned from a query with a natural join:
SELECT A, B FROM A NATURAL JOIN B
   would translate to Natural Algebra as

$${Q}_{3} = {Π}_{\{ A . oid , B . oid \}} ( A B )$$

### Example 23. Property Chains

The domain of the oid attributes introduced in the previous example is formally defined as a set of objects in the respective class:

$$Dom ( A . oid ) {=}^{Def} A$$

While A as a k-relation may grow or shrink during the database lifetime, the respective domain will be changing accordingly. Other attributes in the same or other k-relations might have the same domain, for example a class B might have a field y, referring to objects of class A:
Dom(B.y)=A.

A Starcounter QL query may be formulated to retrieve all objects of class B, together with objects of class A which they reference with y field:
SELECT B, y FROM B
   which would translate to

$${Q}_{2} = {Π}_{\{ B . oid , B . y \}} ( {ρ}_{B .} ( B ) )$$

and the domain of the result of such query would be a Cartesian product of two classes as domains:

$$D o m ( {Q}_{2} ) = B \times A$$

However, a query may instead retrieve values of x field of objects which are referred by y field of objects of class B:
SELECT y.x FROM B which would translate to an equi-join using an oid attribute:

$${Q}_{3} = {Π}_{\{ B . y . x \}} ( {{ρ}_{B .} ( B )}_{〈 B . y 〉} {〈 B . y . oid 〉}_{} {ρ}_{B . y .} ( A ) )$$

Note that a prefix for the table A, representing the domain Dom(B.y) is chosen as the fully-prefixed name of that attribute.

In order to perform this translation, one needs to know the column type definition Dom(B.y)=A, which is part of the database schema. In Starcounter QL, one can define a table using a name of another table as a column type:
CREATE TABLE B (y A)

A star syntax can be used to extract all non-oid fields of y objects:
SELECT y. * FROM B

Which would translate to Natural Algebra as

$${Q}_{4} = {Π}_{B . y . {H}^{*} ( A )} ( {{ρ}_{B .} ( B )}_{〈 B . y 〉} {〈 B . y . oid 〉}_{} {ρ}_{B . y .} ( A ) )$$

Longer property chains, as in
SELECT y.x.z FROM B
   where Dom(x)=C and z∈H(C), will translate to a superposition of joins:

$${Q}_{5} = {Π}_{\{ B . y . x . z \}} ( {( {{ρ}_{B .} ( B )}_{〈 B . y 〉} {〈 B . y . oid 〉}_{} {ρ}_{B . y .} ( A ) )}_{〈 B . y . x 〉} {〈 B . y . x . oid 〉}_{} {ρ}_{B . y . x} ( C ) )$$

### Note on Null-Tolerance in Property Chains

There is an ongoing discussion regarding the semantics of property chain with respect to the NULL values in object-referencing attributes. The queries Q₃-Q₅ from the above example, given the Natural Algebra translations provided, will return no rows for those B.y values which are NULL.

Some applications might instead prefer as many result rows as there are bindings for B.y, whether NULL or not. This alternative semantics can be easily accommodated, by using left equi-joins instead of the default (inner) equi-joins:

$${Q}_{3} = {Π}_{\{ B . y . x \}} ( {{ρ}_{B .} ( B )}_{〈 B . y 〉} {〈 B . y . oid 〉}_{} {ρ}_{B . y .} ( A ) ) \\ {Q}_{4} = {Π}_{B . y . {H}^{*} ( A )} ( {{ρ}_{B .} ( B )}_{〈 B . y 〉} {〈 B . y . oid 〉}_{} {ρ}_{B . y .} ( A ) ) \\ {Q}_{5} = {Π}_{\{ B . y . x . z \}} ( {( {{ρ}_{B .} ( B )}_{〈 B . y 〉} {〈 B . y . oid 〉}_{} {ρ}_{B . y .} ( A ) )}_{〈 B . y . x 〉} {〈 B . y . x . oid 〉}_{} {ρ}_{B . y . x} ( C ) )$$

According to the definition of the left join, these Natural Algebra expressions with return NULL values in those result rows where there is no object of class A with oid matching B.y attribute (or no object of class C with oid attribute matching the respective B.y.x, for the case of Q₅).

### Note on Intermediate Translations

For the embodiments that perform a translation to the Natural Algebra in a schema-ignorant way (which was possible in all the examples so far), translating a property chain directly to a join is not possible. An intermediate translation can be formed instead:

The last two queries from the Example 23 can be first translated as

$${Q}_{4} = {Π}_{\{ B , y [ * ] \}} ( {ρ}_{B .} ( B ) ) \\ {Q}_{5} = {Π}_{\{ B . y [ x ] [ z ] \}} ( {ρ}_{B .} ( B ) )$$

These translations use a property dereference [⋅] operator applied to a certain property in a projection. Now we can formulate a transformation rule translating every occurrence of [⋅] to an equi-join, thus making [⋅] a derived operator:

$${R}_{1} : {\prod }_{\{ a [ * ] \} ⋃ X} ( B ) {⟶}^{a ∈ H ( B ) ⋀ ∃ A : A = Dom ( a )} {\prod }_{a . H * ( A ) ⋃ X} ( {B}_{〈 a 〉} {〈 a . oid 〉}_{} {ρ}_{a .} ( A ) )$$

$${R}_{2} : {\prod }_{\{ a [ p ] \} ⋃ X} ( B ) {⟶}^{a ∈ H ( B ) ⋀ ∃ A : A = Dom ( a ) ⋀ p ∈ H ( A )} {\prod }_{\{ a . p \} ⋃ X} ( {B}_{〈 a 〉} {〈 a . oid 〉}_{} {ρ}_{a .} ( A ) )$$

Where B is any Natural Algebra expression, X is any header expression, p is a property and a is an attribute expression which may involve another instance of [⋅] operator. In case a is not a simple property, but has a form b[g], the condition Dom(a)∈A is defined as follows:

$$Dom ( b [ q ] ) = A {⇔}^{Def} ∃ C : C = Dom ( b ) ⋀ q ∈ H ( C ) ⋀ ∃ A : Dom ( q )$$

which effectively means that attribute q has A as its domain, and also belongs to the domain of b. This definition works recursively, since b is not required to be a single attribute either.

The first application of the rule R₂ to Q₅ with the following match:

| symbol | a | p | b | X | B | C | A |
|---|---|---|---|---|---|---|---|
| match | B.y | x | z | Ø | ρ_{B}.(B) | . . . | A |

would transform it to:

$$\begin{matrix}{Q}_{5}^{( 1 )} = {Π}_{\{ B . y [ x ] . z \}} ( {{ρ}_{B .} ( B )}_{〈 B . y [ x ] 〉} {〈 B . y [ x ] . oid 〉}_{} {ρ}_{B . y [ x ] .} ( C ) ) = \\ = {Π}_{\{ B . y [ x ] . z \}} ( {ρ}_{B .} ( B ) {ρ}_{B . y [ x ] .} ( C ) \{ B . y [ x ] = B . y [ x ] . oid \} )\end{matrix}$$

Indeed, the dereference operator can appear as part of any property used in a scalar expression defining a generated set, so we will need another rewrite rule for this case:

$${R}_{3} : {\prod }_{\{ a [ p ] . b \} ⋃ X} ( B C ) {{⟶}^{a ∈ H ( B ) ⋀ ∃ A : A = Dom ( a ) ⋀ p ∈ H ( A )}}_{C ( a [ p ] . c \to a . p . c ) D} {\prod }_{\{ a . p . b \} ⋃ X} ( ( {B}_{〈 a 〉} {〈 a . oid 〉}_{} {ρ}_{a .} ( A ) ) D )$$

where a and b are property expressions, p is a single property, and X is the set of other attributes in the projection, B is a Natural Algebra expression with header containing attribute denoted by a, and C is the rest of the expression, which will be bound to the join identity element { [symbol] [symbol] *1} if there are no more terms in the join.

The value transformation function C(a[p]c→a.p.c)D obtains a value for rule variable D by exhaustively applying the given attribute expression transformation as a sub-rule to the binding of the variable C in the input pattern. Note that c bindings might be different in each application of this sub-rule, whereas a and p are bound by the host rule.

Applying rule R3 to the latest form of Q₅ with the following match:

| symbol | a | p | b | X | B | C | A |
|---|---|---|---|---|---|---|---|
| match | B.y | x | z | Ø | ρ_{B.} (B) | . . . | A |

we obtain Q₅⁽²⁾ which is the translation of Q₅ in the Example 23:

$$\begin{matrix}{Q}_{5}^{( 2 )} = {Π}_{\{ B . y . x . z \}} ( ( {{ρ}_{B .} ( B )}_{〈 B . y 〉} {〈 B . y . oid 〉}_{} {ρ}_{B . y .} ( A ) ) {ρ}_{B . y . x .} ( C ) \{ B . y . x = \\ B . y . x . oid \} ) = \\ = {Π}_{\{ B . y . x . z \}} ( {( {{ρ}_{B .} ( B )}_{〈 B . y 〉} {〈 B . y . oid 〉}_{} {ρ}_{B . y .} ( A ) )}_{〈 B . y . x 〉} {〈 B . y . x . oid 〉}_{} {ρ}_{B . y . x} ( C ) )\end{matrix}$$

In case of the left join based translation of the property chains, as discussed in the previous note, rules R₁-R₅ from this section would instead introduce left equi-join [symbol] operator in the output pattern.

### Example 24. Path Expressions: Reverse Properties

Starcounter QL supports a full set of path expressions, borrowed from W3C SPARQL 1.1 Standard. The key semantic feature is the ability to return zero, one, or many values for a property. In Example 23 we were assuming that B.y attribute acts as a foreign key, i.e. it points to at most one existing object in Dom(y). However, such constraint is not required for the property chain syntax to work.

One example of multi-value property is a reverse property. A Starcounter QL query
SELECT p.employer. \hat{ }employer FROM Person p WHERE p.name=‘Joe’ given the schema
CREATE TABLE Company (name TEXT)
CREATE TABLE Person (name TEXT, employer Company)
   would return objects of class Person, one object for each employee of a company where person named ‘Joe’ is employed. While p.employer has the type Company, p. employer.\hat{ }employer property chain results in the class having employer property of type Company, that is, Person class (it is currently being discussed how to handle cases where multiple classes match this criterion).

The Natural Algebra translation of this query, given the presented schema, is

$$Q = {Π}_{\{ Person . oid \}} ( ( {{ρ}_{p .} ( Person )}_{〈 p . employer 〉} {〈 Person . employer 〉}_{} {ρ}_{Person .} ( Person ) )$$

$$\{ p . name = ‘ Joe ’ \} )$$

which corresponds to an executable S-expression in the preferred embodiment

```
(PROJECT (N-JOIN (E-JOIN (PREFIX Person “p”)
      (PREFIX Person “Person”)
      #(employer) #(employer))
    (FILTER (EQUAL p.name “Joe”)))
  #(Person.oid))
```

Table (class) Company does not participate in the expression, although it is the domain of the employer attribute used in the equi-join.

As in the previous case, this translation can be obtained in two steps, (1) a straightforward schema-ignorant translation using the reverse property dereference \hat{ }[⋅] operator:

$$Q = {Π}_{\{ p . employer \hat{} [ employer ] \}} ( {ρ}_{p .} ( Person ) \{ p . name = ‘ Joe ’ \} )$$

and (2) rule-based transformation for the \hat{ }[⋅] found among the projection attributes:

$${R}_{4} : {\prod }_{\{ a \hat{} [ p ] \} ⋃ X} ( B ) {⟶}^{∃ A : A = Dom ( a ) = Dom ( p ) ⋀ ∃ C : p ∈ H ( C )} {\prod }_{\{ C \_ oid \} ⋃ X} ( {B}_{〈 a 〉} {〈 C . p 〉}_{} {ρ}_{C .} ( C ) )$$

with the following match

| symbol | a | p | X | B | A | C |
|---|---|---|---|---|---|---|
| match | p.employer | employer | Ø | ρ_{p.} | Company | Person |
| | | | | (Person) | | |

resulting in the translation of the query based on the equi-join, as presented above.

### Example 25. Path Expressions: Alternative Paths

Another case of a path expression producing 0-to-many results for each object instance is the syntax of alternative paths. Consider a slightly modified Person table
CREATE TABLE Person (name TEXT, employer Company, lastEmployer Company)

And a query returning all people who have company named ‘Starcounter’ as a current or previous (last) employer:
SELECT p FROM Person p WHERE p. (employer|lastEmployer) .name=‘Starcounter’

Is translated to a theta-join, having a disjunction in the join predicate:

$$Q =$$

$${Π}_{\{ p . oid \}} ( ( {ρ}_{p .} ( Person ) {p . employer = Company . oid ∨ p . lastEmployer = Company . oid}_{} {ρ}_{Company .}$$

$$( Company ) ) \{ Company . name = ‘ Startcounter ’ \} )$$

which corresponds to an executable S-expression in the preferred embodiment (note the theta-join is ‘flattened’ to a natural join and a filter):

```
(PROJECT (N-JOIN (PREFIX Person “p”) (PREFIX Company
“Company”)
    (FILTER (OR (EQUAL p.employer Company.oid)
      (EQUAL p.lastEmployer Company.oid)))
    (FILTER (EQUAL Company.name “Starcounter”)))
  #(p.oid))
```

Again, in order to arrive to this translation, the type of the properties employer and lastEmployer needs to be known. An intermediate translation can be constructed in a schema-ignorant way first, using the alternative ∨ operator inside the property reference:

$$Q = {Π}_{\{ p . oid \}} ( {ρ}_{p .} ( Person ) \{ p [ employer ∨ lastEmployer ] [ name ] =$$

$$‘ Startcounter ’ \} )$$

A transformation rule, aware of the types of alternative property paths would then simply translate the occurrences of the property references with ∨ operator inside to the theta-joins (or, depending on the chosen property chain semantics, to the left theta-joins) with disjunction-based join criterion.

Future versions of Starcounter QL may allow different object types of the alternative property paths, in which case the type of the property chain, or the handling of further properties along the property chain (as name in this case), if they only belong to some but not all alternative types, needs to be defined at that point.

### 6. Query Execution Environment

The Natural Algebra expressions are capable of fully encoding database queries translated from a wide range of query languages. They can also be transformed to different forms using the transformation rules framework, including the introduction of physical operators into the expression.

Any embodiment should include an executable form of each valid Natural Algebra expression, and this form should be reachable with transformation rules available in the system. For example, the preferred embodiment based on S-expressions, as shown in examples in Section 2, provides a fully composable context-free execution of each Natural Algebra operator, hence any expression form is executable there.

A different embodiment might define a dedicated set of physical operators, partially or completely disjoint with the set of basic and derived Natural Algebra operators introduced so far. A Natural Algebra expression, once fully translated to use this set of operators, may be set to a compiler or interpreter subsystem, where, given access to the data in the database, computation of the result will take place.

Any such execution environment will either feature context-free execution (and thus require correlated subquery rewriting techniques such as predicate lifting and finite scaffolds) or facilitate passing of execution context to subexpressions in the form of bound attributes/variables.

### 6.1 Compositional (Context-Free) Execution Model

For example, let's return to the query from Example 7, which was partially translated to use physical operator Range^{y} in Section 4.3:

$$Q = {ρ}_{A .} ( A ) {ρ}_{B .} ( {Range}_{( - ∞ , A . x )}^{y} ( B ) )$$

More decisions on its execution may be taken by choosing an access method for A, for example Scan(A), and a particular implementation of the natural join, for example nested-loop join [symbol] ^{NLJ}:

$${Q}^{( 1 )} = {ρ}_{A .} ( Scan ( A ) ) {NLJ}^{} {ρ}_{B .} ( {Range}_{( - ∞ , A . x )}^{y} ( B ) )$$

Even in context-free setting, a nested-loop join operator allows local passing of the attributes bound by the left operand into the right operand, and a the renaming operator ρ, which deals only with headers, is transparent to this context passing, hence A.x is ‘visible’ when executing Range^{y}.

6.2 Execution Model with Full Context Passing

In Example 14 we translated an SQL query with correlated aggregate subquery into a Natural Algebra expression without any finite scaffolds or lifted predicates:

$${Q}_{1} = ( {ρ}_{A .} ( A ) \{ A . w > 0 \} ) {ρ}_{C .} ( {Ξ}_{\{ A . x \}} ( {Sum}_{\{ B . y \}}^{\{ z \}} , {ρ}_{B .} ( B ) \{ A . x > y \} ) )$$

A number of logical-to-physical transformations would further produce a query using range indexes on both stored k-relations, and a nested-loop join:

$${Q}_{2}^{( 1 )} = {ρ}_{A .} ( {Range}_{( 0 , + ∞ )}^{w} ( A ) ) {NLJ}^{} {ρ}_{C .} ( {Ξ}_{\{ A . x \}} ( {Sum}_{\{ B . y \}}^{\{ z \}} , {ρ}_{B .} ( {Range}_{( - ∞ , A . x )}^{y} ( B ) ) )$$

Executing this query will require passing the A.x bindings all the way into the subexpressions in the right operand of the nested-loop join. In particular, executing the grouping and aggregate operator Ξ with grouping variable bound would effectively produce zero or one group (result tuple) per binding.

One of the more straightforward ways to implement such execution model would be to
1) Allocate an ‘empty’ tuple, capable of containing all attributes used anywhere in the Natural Algebra expression, whether they are projected-out or returned in the result.
2) Recursively execute the physical Natural Algebra expression starting from the root allowing the operators to iterate on the results of their arguments' subexpressions. Every return from any such operator provides values for some of the attributes in the result tuple. This result tuple is visible at all levels.
3) Each time the top operator returns a row, the result tuple is complete, and returned as part of the result set.
4) The subsequent recursive calls through the operator tree rewrite the attribute bindings.

1-9. (canceled)

10. A system comprising:
a non-transitory computer-readable medium;
one or more processors communicatively coupled to the non-transitory computer-readable medium, the one or more processors configured to execute processor-executable instructions stored in the non-transitory computer-readable medium to:
receive, from a software application, a database query according to a first query language, the database query directed to a database;
generate an algebraic query expression from the database query according to an algebraic query language, the algebraic query language defining only two basic operators consisting of a natural-join operator and a natural-union operator;
logically optimize the algebraic query expression to generate a logically optimized algebraic query expression;
physically optimize the logically optimized algebraic query expression to generate a physically optimized algebraic query expression;
execute the physically optimized algebraic query expression to identify information stored in the database responsive to the database query; and
provide the identified information to the software application.

11. The system of claim 10, wherein the one or more processors are configured to execute further processor-executable instructions stored in the non-transitory computer-readable medium to generate one or more algebraic query expressions, each comprising one or more of the natural-join operator, the natural-union operator, or one or more derived operators.

12. The system of claim 10, wherein the one or more processors are configured to execute further processor-executable instructions stored in the non-transitory computer-readable medium to perform one or more transformations of the algebraic query expression to logically optimize, at least in part, the algebraic query expression.

13. The system of claim 10, wherein the first query language is one query language of a plurality of query languages supported by the system, and wherein the one or more processors are configured to execute further processor-executable instructions stored in the non-transitory computer-readable medium to:
receive, from a second software application, a second database query according to any query language of the plurality of query languages, the second database query directed to the database;
generate a second algebraic query expression from the second database query according to the algebraic query language;
logically optimize the second algebraic query expression to generate a second logically optimized algebraic query expression; physically optimize the second logically optimized algebraic query expression to generate a second physically optimized algebraic query expression;
execute the second physically optimized algebraic query expression to identify second information stored in the database responsive to the second database query; and
provide the identified second information to the second software application.

14. The system of claim 10, wherein the database is a first database, the first database having a first database type of one of a relational database type, an object-oriented database type, an object-relational database type, or a graph database type; and wherein the one or more processors are configured to execute further processor-executable instructions stored in the non-transitory computer-readable medium to:
receive, from a second software application, a second database query according to a second query language different from the first query language, the second database query directed to a second database, wherein the second database has a second database type of one of the relational database type, the object-oriented database type, the object-relational database type, or the graph database type, the second database type different from the first database type;
generate a second algebraic query expression from the second database query according to the algebraic query language;
logically optimize the second algebraic query expression to generate a second logically optimized algebraic query expression;
physically optimize the second logically optimized algebraic query expression to generate a second physically optimized algebraic query expression;
execute the second physically optimized algebraic query expression to identify second information stored in the second database responsive to the second database query; and
provide the identified second information to the second software application.

15. The system of claim 10, wherein the natural-join operator is defined to produce a k-relation consisting of joined pairs of compatible tuples from one or more argument k-relations, and wherein the natural-union operator is defined to produce a k-relation consisting of common attributes of all tuples of one or more argument k-relations.

16. A method comprising:
receiving, from a software application, a database query according to a first query language, the database query directed to a database;
generating an algebraic query expression from the database query according to an algebraic query language, the algebraic query language defining only two basic operators consisting of a natural-join operator and a natural-union operator;
logically optimizing the algebraic query expression to generate a logically optimized algebraic query expression;
physically optimizing the logically optimized algebraic query expression to generate a physically optimized algebraic query expression;
executing the physically optimized algebraic query expression to identify information stored in the database responsive to the database query; and
providing the identified information to the software application.

17. The method of claim 16, further comprising generating one or more algebraic query expressions, each comprising one or more of the natural-join operator, the natural-union operator, or one or more derived operators.

18. The method of claim 16, further comprising logically optimizing, at least in part, the algebraic query expression.

19. The method of claim 16, wherein the first query language is one query language of a plurality of supported query languages, and further comprising:
receiving, from a second software application, a second database query according to any query language of the plurality of supported query languages, the second database query directed to the database;
generating a second algebraic query expression from the second database query according to the algebraic query language;
logically optimizing the second algebraic query expression to generate a second logically optimized algebraic query expression; physically optimize the second logically optimized algebraic query expression to generate a second physically optimized algebraic query expression;
executing the second physically optimized algebraic query expression to identify second information stored in the database responsive to the second database query; and
providing the identified second information to the second software application.

20. The method of claim 16, wherein the database is a first database, the first database having a first database type of one of a relational database type, an object-oriented database type, an object-relational database type, or a graph database type; and further comprising:
receiving, from a second software application, a second database query according to a second query language different from the first query language, the second database query directed to a second database, wherein the second database has a second database type of one of the relational database type, the object-oriented database type, the object-relational database type, or the graph database type, the second database type different from the first database type;
generating a second algebraic query expression from the second database query according to the algebraic query language;
logically optimizing the second algebraic query expression to generate a second logically optimized algebraic query expression;
physically optimizing the second logically optimized algebraic query expression to generate a second physically optimized algebraic query expression;
executing the second physically optimized algebraic query expression to identify second information stored in the second database responsive to the second database query; and
providing the identified second information to the second software application.

21. The method of claim 16, wherein the natural-join operator is defined to produce a k-relation consisting of joined pairs of compatible tuples from one or more argument k-relations, and wherein the natural-union operator is defined to produce a k-relation consisting of common attributes of all tuples of one or more argument k-relations.

22. A non-transitory computer-readable medium comprising processor-executable instructions configured to cause one or more processors to:
receive, from a software application, a database query according to a first query language, the database query directed to a database;
generate an algebraic query expression from the database query according to an algebraic query language, the algebraic query language defining only two basic operators consisting of a natural-join operator and a natural-union operator;
logically optimize the algebraic query expression to generate a logically optimized algebraic query expression;
physically optimize the logically optimized algebraic query expression to generate a physically optimized algebraic query expression;
execute the physically optimized algebraic query expression to identify information stored in the database responsive to the database query; and
provide the identified information to the software application.

23. The non-transitory computer-readable medium of claim 22, further comprising processor-executable instructions configured to cause one or more processors to generate one or more algebraic query expressions, each comprising one or more of the natural-join operator, the natural-union operator, or one or more derived operators.

24. The non-transitory computer-readable medium of claim 22, further comprising processor-executable instructions configured to cause one or more processors to perform one or more transformations of the algebraic query expression to logically optimize, at least in part, the algebraic query expression.

25. The non-transitory computer-readable medium of claim 22, wherein the first query language is one query language of a plurality of supported query languages, and further comprising processor-executable instructions configured to cause one or more processors to:
receive, from a second software application, a second database query according to any query language of the plurality of supported query languages, the second database query directed to the database;
generate a second algebraic query expression from the second database query according to the algebraic query language;
logically optimize the second algebraic query expression to generate a second logically optimized algebraic query expression; physically optimize the second logically optimized algebraic query expression to generate a second physically optimized algebraic query expression;
execute the second physically optimized algebraic query expression to identify second information stored in the database responsive to the second database query; and
provide the identified second information to the second software application.

26. The non-transitory computer-readable medium of claim 22, wherein the database is a first database, the first database having a first database type of one of a relational database type, an object-oriented database type, an object-relational database type, or a graph database type; and further comprising processor-executable instructions configured to cause one or more processors to:
receive, from a second software application, a second database query according to a second query language different from the first query language, the second database query directed to a second database, wherein the second database has a second database type of one of the relational database type, the object-oriented database type, the object-relational database type, or the graph database type, the second database type different from the first database type;
generate a second algebraic query expression from the second database query according to the algebraic query language;
logically optimize the second algebraic query expression to generate a second logically optimized algebraic query expression;
physically optimize the second logically optimized algebraic query expression to generate a second physically optimized algebraic query expression;
execute the second physically optimized algebraic query expression to identify second information stored in the second database responsive to the second database query; and
provide the identified second information to the second software application.

27. The non-transitory computer-readable medium of claim 22, wherein the natural-join operator is defined to produce a k-relation consisting of joined pairs of compatible tuples from one or more argument k-relations, and wherein the natural-union operator is defined to produce a k-relation consisting of common attributes of all tuples of one or more argument k-relations.
